(19) United States
(12) Patent Application Publication
(10) Pub. No.: US 2013/0183584 A1
(43) Pub. Date: Jul. 18, 2013

(54) LITHIUM-SILICATE-BASED COMPOUND AND PRODUCTION PROCESS FOR THE SAME

(71) Applicants: Toshikatsu Kojima, Ikeda-shi (JP); Mitsuharu Tabuchi, Ikeda-shi (JP); Takuhiro Miyuki, Ikeda-shi (JP); Tetsuo Sakai, Ikeda-shi (JP); Akira Kojima, Kariya-shi (JP); Junichi Niwa, Kariya-shi (JP); Kazuhito Kawasumi, Kariya-shi (JP)

(72) Inventors: Toshikatsu Kojima, Ikeda-shi (JP); Mitsuharu Tabuchi, Ikeda-shi (JP); Takuhiro Miyuki, Ikeda-shi (JP); Tetsuo Sakai, Ikeda-shi (JP); Akira Kojima, Kariya-shi (JP); Junichi Niwa, Kariya-shi (JP); Kazuhito Kawasumi, Kariya-shi (JP)

(73) Assignee: KABUSHIKI KAISHA TOYOTA JIDOSHOKKI, Kariya-shi, Aichi (JP)

(21) Appl. No.: 13/824,913

(22) PCT Filed: Oct. 31, 2011
(86) PCT No.: PCT/JP2011/006091

§ 371 Date: Mar. 18, 2013

(30) Foreign Application Priority Data
Nov. 5, 2010 (JP) 2010-249103

(51) Int. Cl. H01M 4/505; H01M 4/134; H01M 4/131

(52) U.S. Cl. CPC H01M 4/505; H01M 4/131; H01M 4/134
USPC 429/220; 252/182.1; 429/221; 429/224; 429/223; 429/229; 429/231.5; 429/231.6

(57) ABSTRACT

A production process for lithium-silicate-based compound is characterized in that:
a lithium-silicate compound is reacted with a transition-metal-element-containing substance including iron and/or manganese at from 300° C. or more to 600° C. or less within a molten salt including at least one member being selected from the group consisting of alkali-metal salts under a mixed-gas atmosphere including carbon dioxide and a reducing gas;
wherein said transition-metal-element-containing substance includes a deposit that is formed by alkalifying a transition-metal-containing aqueous solution including a compound that includes iron and/or manganese. In accordance with the present production process, lithium-silicate-based compounds including silicon excessively are obtainable.

In accordance with the present invention, it is possible to produce materials, which have better battery characteristics than do conventional ones, by means of relatively easy means, regarding lithium-silicate-based materials that are useful as a positive-electrode material for secondary battery.

### TECHNICAL FIELD

The present invention relates to a production process for lithium-silicate-based compound, which is useful mainly as a positive-electrode active material of lithium-ion secondary battery, and to uses or applications for the lithium-silicate-based compound that is obtainable by this process.

### BACKGROUND ART

Lithium secondary batteries have been used widely as power sources for portable electronic instruments, because they are small-sized and have high energy densities. Recently, as for their positive-electrode active materials, lithium-silicate-based compounds, such as Li₂FeSiO₄ whose theoretical capacity is 331.3 mAh/g and Li₂MnSiO₄ whose theoretical capacity is 333.2 mAh/g, have been attracting attention. Since the lithium-silicate-based compounds are inexpensive; since they are made up of constituent metallic elements only that are abundant in the resource amount so that their loads to the environment are low; since they exhibit the high theoretical charging/discharging capacity of lithium ion, respectively; and since they are a material that do not discharge any oxygen at the time of high temperatures, they have been attracting attention as for a positive-electrode material for next-generation lithium-ion secondary battery.

As for synthesizing methods for the lithium-silicate-based compounds, the hydrothermal synthesis method, and the solid-phase reaction method have been known. Of these methods, it is feasible to obtain fine particles with particle diameters of from 1 to 10 nm approximately by means of the hydrothermal synthesis method. However, in silicate-based compounds being obtained by means of the hydrothermal synthesis method, there are the following problems: doping elements are less likely to dissolve; the phases of impurities are likely to be present mixedly; and additionally battery characteristics being expressed are not quite satisfactory. These are believed to result from the fact that, in addition to the fact that the synthesizing temperature is so low that it takes a long time for the reaction, it is difficult to synthesize the lithium-silicate-based compounds unless the lithium raw material is charged excessively. Moreover, since a hydrothermal reaction apparatus that is used for such a method requires special facilities for the high-pressure treatment, the apparatus is disadvantageous for mass-producing the lithium-silicate-based compounds.

On the other hand, in the solid-phase reaction method, although it is feasible to dissolve doping elements because it is needed to cause reactions at such high temperatures as 650° C. or more for a long period of time, the resulting crystal grains become larger to 10 μm or more, thereby leading to such a problem that the diffusion of ions is slow. Besides, since the reactions are caused at the high temperatures, the doping elements, which cannot be kept being dissolved completely during a subsequent cooling process, have come to precipitate as impurities in the cooling process, and so there is also such a problem that the resultant resistance becomes higher. In addition, since lithium-deficient or oxygen-deficient lithium-silicate-based compounds have been made due to the heating being done up to the high temperatures, there is also such a problem that it is difficult to increase capacities or to upgrade cyclabilities (refer to following Patent Literature Nos. 1 through 4).

For example, of these lithium-silicate-based materials being synthesized by means of the above-mentioned methods, Li₂FeSiO₄ is a material showing the highest charging/discharging characteristic ever that has been reported at present, and exhibits a capacity of 160 mAh/g approximately. However, when an assessment is made at 60° C. for Li₂FeSiO₄, there is such a problem that, although a capacity of 150 mAh/g approximately can be produced, the resulting capacity has declined considerably so that a capacity of 60 mAh/g approximately can only be produced when another assessment is made at room temperature therefor under similar conditions.

The present inventors found out a process making it possible to produce materials, whose cyclabilities, capacities, and the like, are improved and hence which exhibit better performance, by means of relatively easy means. In Patent Literature No. 5, there is set forth, as Example No. 1, an iron-containing lithium-silicate-based compound (i.e., Li₂FeSiO₄) that is synthesized by reacting a lithium-silicate compound and iron oxalate one another at 550° C. within a carbonate molten salt including lithium carbonate under a reducing atmosphere.

### RELATED TECHNICAL LITERATURE

### Patent Literature

Patent Literature No. 1: Japanese Unexamined Patent Publication (KOKAI) Gazette No. 2008-218303;
Patent Literature No. 2: Japanese Unexamined Patent Publication (KOKAI) Gazette No. 2007-335325;
Patent Literature No. 3: Japanese Unexamined Patent Publication (KOKAI) Gazette No. 2001-266882;
Patent Literature No. 4: Japanese Unexamined Patent Publication (KOKAI) Gazette No. 2008-293661; and
Patent Literature No. 5: International Publication No. 2010/089931

### SUMMARY OF THE INVENTION

### Assignment to be Solved by the Invention

In accordance with the process as set forth in Patent Literature No. 5, it was possible to synthesize lithium-silicate-based compounds whose cyclabilities were better and capacities were higher than those being produced by means of the conventional solid-phase reaction process. Hence, the present inventors developed this achievement furthermore, and thereby tried to investigate a production process for lithium-silicate-based compound whose characteristics as a battery material are improved much more.

The present invention aims at providing a process, which makes it possible to produce by relatively easy means a material whose cyclability, capacity, and the like, are improved so that it has better battery characteristics than those of conventional ones, with regard to lithium-silicate-based materials that are useful as a positive-electrode material for lithium-ion secondary battery.

### Means for Solving the Assignment

The present inventors investigated a novel production process for lithium-silicate-based compound; and besides they found out anew that noble lithium-silicate-based compounds, which contain silicon more excessively than the stoichiometric compositions, are obtainable by means of that production process, and that the thus obtained compounds have excellent charging/discharging characteristics.

Specifically, a silicon-rich lithium-silicate-based compound according to the present invention is characterized in that:

the silicon-rich lithium-silicate-based compound is being expressed by a compositional formula:

Li_{2+a-b}A_{b}M₁₋ₓM′ₓSi_{1+α}O_{4+c}:

where “A” is at least one element that is selected from the group consisting of Na, K, Rb and Cs;

“M” is at least one element that is selected from the group consisting of Fe and Mn;

“M′” is at least one element that is selected from the group consisting of Mg, Ca, Co, Al, Ni, Nb, Ti, Cr, Cu, Zn, Zr, V, Mo and W; and

the respective subscripts are specified as follows:
0≦“x”≦0.5;
−1<“a”<1;
0≦“b”<0.2;
0<“c”<1; and
0<“α”≦0.2;

in the formula.

In the silicon-rich lithium-silicate-based compound, it is believed that excessive silicon atoms exist between interstitial sites. When silicon exists between interstices, the resulting crystal structure is stabilized, so that it is assumed that there arises an advantageous effect, stabilizing the cyclability of secondary battery, in a case where it is used as a positive-electrode material. In addition, since silicon serving as a positive ion exists between interstices and accordingly the distance between lithium ions serving as positive ions gets closer, the lithium ions become likely to come off by means of electrostatic action, and thereby another advantageous effect, lowering charging voltage, can also be expected. As a result, it becomes feasible to obtain a high charging capacity even when charging is not done up to high voltage. Moreover, lowering charging voltage leads to making it possible to reduce an irreversible capacity that results from the decomposition of electrolytic liquid, so that it is possible for the resulting lithium-silicate-based compound to make materials that have high charging/discharging efficiencies.

A production process for silicon-rich lithium-silicate-based compound according to the present invention is characterized in that:

in a production process for lithium-silicate-based compound in which a lithium-silicate compound being expressed by Li₂SiO₃ is reacted with a transition-metal-element-containing substance including at least one member being selected from the group consisting of iron and manganese at from 300° C. or more to 600° C. or less within a molten salt including at least one member being selected from the group consisting of alkali-metal salts under a mixed-gas atmosphere including carbon dioxide and a reducing gas;

said transition-metal-element-containing substance includes a deposit that is formed by alkalifying a transition-metal-containing aqueous solution including a compound that includes at least one member being selected from the group consisting of iron and manganese.

The transition-metal-element-containing substance is a supply source of iron and/or manganese. In the production process for lithium-silicate-based compound according to the present invention, a deposit, which is formed by alkalifying a transition-metal-element-containing aqueous solution including a compound that includes at least member being selected from the group consisting of iron and manganese, is used as the transition-metal-element-containing substance, instead of manganese oxalate and iron oxalate that have been heretofore used conventionally therefor.

In short, in accordance with the production process according to the present invention, lithium-silicate-based compounds are obtainable, lithium-silicate-based compounds whose compositions and eventually properties differ from those of lithium-silicate-based compounds that were obtainable by the conventional production process in which manganese oxalate or iron oxalate, and the like, is used. As a result, it becomes feasible especially to synthesize lithium-silicate-based compounds whose characteristics as a battery material are much more outstanding. The following are believed to be one of the reasons why using such a deposit leads to making lithium-silicate-based compounds obtainable, lithium-silicate-based compounds whose characteristics differ from those of the conventional ones.

It is believed that the deposit, which is obtainable by means of the above-mentioned procedure, is porous, and accordingly it is assumed that the reactivity is higher than that of manganese oxalate or iron oxalate, and the like. Consequently, it is believed that, due to the difference in the transition-metal-element-containing substance, lithium-silicate-based compounds possessing distinct properties are synthesized even under the same synthesizing conditions as the conventional ones. For example, lithium-silicate-based compounds being synthesized by means of the production process according to the present invention include silicon in excess of the stoichiometric composition of lithium-silicate-based compound. Moreover, since acicular or needle-shaped particles, and plate-shaped particles are observed when observing the configurations of lithium-silicate-based compounds being obtained by means of the production process according to the present invention, it is understood the growth directions are anisotropic. That is, in the production process according to the present invention, there is such a possibility that lithium-silicate-based compounds having orientations in which the crystals grow anisotropically so as to make orientations in which lithium ions are likely to be sorbed and released in a case where the resulting lithium-silicate-based compounds are used as a positive-electrode active material for lithium-ion secondary battery.

Moreover, in accordance with the production process according to the present invention, since the synthesis at lower temperatures is feasible depending on the types of the molten salt, the crystal growth is inhibited so that compounds with fine crystal grains are obtainable. And, since the reactivity of the deposit is higher, it is possible to produce lithium-silicate-based compounds efficiently even when lowering the synthesis temperature.

### Effect of the Invention

In accordance with the production process for lithium-silicate-based compound according to the present invention, lithium-silicate-based compounds are obtainable easily with use of raw materials that are inexpensive, whose resource amounts are great, and whose environmental loads are low. Moreover, lithium-silicate-based compounds being obtainable by means of the production process according to the present invention show excellent battery characteristics in a case where they are used as a positive-electrode active material for lithium-ion secondary battery, and the like.

### BRIEF DESCRIPTION OF THE DRAWINGS

FIG. 1 illustrates X-ray diffraction patterns of compounds that were synthesized by means of processes according to Example No. 1-1 and Comparative Example No. 1;

FIG. 2 illustrates scanning-electron-microscope (or SEM) photographs of the compounds that were synthesized by means of the processes according to Example No. 1-1 and Comparative Example No. 1;

FIG. 3 illustrates X-ray diffraction patterns of compounds that were synthesized by means of processes according to their respective examples;

FIG. 4 illustrates X-ray diffraction patterns of compounds that were synthesized by means of processes according to Example No. 1-1 and Example No. 4-1;

FIG. 5 illustrates an SEM photograph of a compound that was synthesized by means of a process according to Example No. 2-1;

FIG. 6 illustrates an SEM photograph of a compound that was synthesized by means of a process according to Example No. 2-2;

FIG. 7 illustrates an SEM photograph of a compound that was synthesized by means of a process according to Example No. 1-2;

FIG. 8 illustrates an SEM photograph of a compound that was synthesized by means of a process according to Example No. 3-1;

FIG. 9 illustrates an SEM photograph of a compound that was synthesized by means of a process according to Example No. 4-1;

FIG. 10 is a graph that illustrates charging/discharging characteristics of a secondary battery in which the compound being synthesized by means of the process according to Example No. 1-1 was used as a positive-electrode active material;

FIG. 11 is a graph that illustrates charging/discharging characteristics of a secondary battery in which the compound being synthesized by means of the process according to Example No. 1-2 was used as a positive-electrode active material;

FIG. 12 is a graph that illustrates charging/discharging characteristics of a secondary battery in which the compound being synthesized by means of the process according to Example No. 2-1 was used as a positive-electrode active material;

FIG. 13 is a graph that illustrates charging/discharging characteristics of a secondary battery in which the compound being synthesized by means of the process according to Example No. 2-2 was used as a positive-electrode active material;

FIG. 14 is a graph that illustrates charging/discharging characteristics of a secondary battery in which the compound being synthesized by means of the process according to Example No. 3-1 was used as a positive-electrode active material;

FIG. 15 is a graph that illustrates charging/discharging characteristics of a secondary battery in which the compound being synthesized by means of the process according to Example No. 4-1 was used as a positive-electrode active material; and

FIG. 16 is a graph that illustrates charging/discharging characteristics of a secondary battery in which the compound being synthesized by means of the process according to Comparative Example No. 1 was used as a positive-electrode active material.

### MODES FOR CARRYING OUT THE INVENTION

The present invention will be hereinafter explained in more detail while giving some of embodiment modes according to the present invention. Note that, unless otherwise specified, ranges, namely, “from ‘p’ to ‘q’” being referred to in the present description, involve the lower limit, “p,” and the upper limit, “q.” Moreover, the other ranges, such as “from ‘r’ to ‘s’,” are composable by arbitrarily combining any two of lower limits and upper limits being set forth in the present description. In addition, it is possible to make numeric values, which are selected arbitrarily from within the ranges of numeric values, into other upper and lower limit values.

### Composition of Molten Salt

In a production process for lithium-silicate-based compound according to the present invention, a synthesis reaction of lithium-silicate-based compound is carried out within a molten salt that includes at least one member being selected from the group consisting of alkali-metal salts.

For the alkali-metal salts, at least one member, which is selected from the group consisting of lithium salts, potassium salts, sodium salts, rubidium salts and cesium salts, can be given. Desirable one among them can be lithium salts. In a case where a molten salt including a lithium salt is employed, a lithium-silicate-based compound, in which the formation of impurity phases is less and which includes lithium atoms excessively, is likely to be formed. Lithium-silicate-based compounds, which are obtainable in this manner, make a positive-electrode material for lithium-ion battery that has favorable cyclability and high capacity, respectively.

Moreover, although there are not any limitations on types of the alkali-metal salts, it is desirable to include at least one member of alkali-metal carbonates, alkali-metal nitrates and alkali-metal hydroxides. To be concrete, the following can be given: lithium carbonate (Li₂CO₃), potassium carbonate (K₂CO₃), sodium carbonate (Na₂CO₃), rubidium carbonate (Rb₂CO₃), cesium carbonate (Cs₂CO₃), lithium nitrate (LiNO₃), potassium nitrate (KNO₃), sodium nitrate (NaNO₃), rubidium nitrate (RbNO₃), cesium nitrate (CsNO₃), lithium hydroxide (LiOH), potassium hydroxide (KOH), sodium hydroxide (NaOH), rubidium hydroxide (RbOH), and cesium hydroxide (CsOH). It is advisable to employ one member of these independently, or to mix two or more of them to employ.

For example, although the resulting molten temperature is 700° C. approximately in the case of independent lithium carbonate, it is possible to set the resultant molten temperature at 600° C. or less in the case of making the molten salt into a molten salt between lithium carbonate and the other alkali-metal salt, and thereby it becomes feasible to synthesize targeted lithium-silicate-based compounds at such a relatively low temperature as from 300 to 600° C. As a result, grain growths are inhibited at the time of synthesis reaction, so that fine lithium-silicate-based compounds are formed.

In order to make the molten salt, one or more of the above-mentioned alkali-metal salts can be selected so as to make the resulting molten temperature 600° C. or less. When the alkaline-metal salts are mixed to use, it is advisable to obtain a mixed molten salt by adjusting the mixing ratio so as to make the molten temperature of the resultant mixture 600° C. or less. Since the mixing ratio differs depending on types of the salts, it is difficult to prescribe it in general.

For example, when employing a carbonate mixture in which lithium carbonate is essential and which includes the other carbonate, it is usually preferable that the lithium carbonate can be included in an amount of 30% by mol or more, or furthermore from 30 to 70% by mol, when the entirety of the resulting carbonate mixture is taken as 100% by mol. As a specific example of the carbonate mixture, a mixture can be given, mixture which comprises lithium carbonate in an amount of from 30 to 70% by mol, sodium carbonate in an amount of from 0 to 60% by mol, and potassium carbonate in an amount of from 0 to 50% by mol. As a more preferable specific example of such a carbonate mixture, a mixture can be given, mixture which comprises lithium carbonate in an amount of from 40 to 45% by mol, sodium carbonate in an amount of from 30 to 35% by mol, and potassium carbonate in an amount of from 20 to 30% by mol.

Note that, since the molten temperature (or the melting point) of alkali-metal nitrate and alkali-metal hydroxide is 450° C. (e.g., about that of lithium hydroxide) at the highest, it is possible even for molten salts, which include one member of either nitrate salts or hydroxides independently, to materialize lower reaction temperatures.

### Raw-material Compounds

In the present invention, the following are used as raw materials for supplying Li as well as Fe and/or Mn: a lithium-silicate compound that is expressed by Li₂SiO₃; and a transition-metal-element-containing substance that includes at least one member being selected from the group consisting of iron and manganese.

The transition-metal-containing substance includes a deposit being formed by alkalifying a transition-metal-containing aqueous solution that includes a compound including iron and/or manganese. Explanations will be made hereinafter on a specific formation method for the deposit.

As for a compound including iron and/or manganese, it is possible to employ a component, which is capable of forming a transition-metal-containing aqueous solution (hereinafter may sometimes be set forth as “aqueous solution”) that includes a compound of those above, without any limitations especially. Usually, it is allowable to use a water-soluble compound. As for a specific example of such a water-soluble compound, it is possible to give the following: water-soluble salts, such as chlorides, nitrates, sulfates, oxalates, and acetate; and hydroxides. It is permissible that these water-soluble compounds can either be anhydrides or hydrates. Moreover, even when being non-water-soluble compounds, such as oxides and oxyhydroxides, for instance, it is feasible to dissolve them in water using an acid, such as hydrochloric acid or nitric acid, and then use them as an aqueous solution, respectively. Moreover, it is also allowable to employ each of these raw-material compounds independently for each of the metallic sources, respectively, or it is even permissible to use two or more of them combinedly.

It is also allowable that the transition-metal-element-containing aqueous solution can essentially include iron and/or manganese, and can further include another metal, as the metallic source. From the viewpoint of obtaining a deposit in which the metallic elements exist to be divalent or less, it is preferable that the valence of metals can be so set that the metals exist to be divalent or less even in the resulting aqueous solution. Therefore, the following can be given concretely as for a compound including iron and/or manganese: manganese (II) chloride, manganese (II) nitrate, manganese (II) sulfate, manganese (II) acetate, manganese (III) acetate, manganese (II) acetylacetonate, potassium (VII) permanganate, manganese (III) acetylacetonate, iron (II) chloride, iron (III) chloride, iron (III) nitrate, iron (II) sulfate, iron (III) sulfate; and hydrates of these. In addition, it is even permissible to generate a deposit including iron and/or manganese along with the other metal with use of the following, if needed: magnesium chloride, magnesium nitrate, magnesium oxalate, magnesium sulfate, magnesium acetate, calcium chloride, calcium nitrate, calcium oxalate, calcium sulfate, calcium acetate, cobalt (II) chloride, cobalt (II) nitrate, cobalt (II) oxalate, cobalt (II) sulfate, cobalt (II) acetate, aluminum (III) chloride, aluminum (III) nitrate, aluminum (III) oxalate, aluminum (III) sulfate, aluminum (III) acetate, nickel (II) chloride, nickel (II) nitrate, nickel (II) oxalate, nickel (II) sulfate, nickel (II) acetate, niobium chloride, titanium chloride, titanium sulfate, chromium (III) chloride, chromium (III) nitrate, chromium (III) sulfate, chromium (III) acetate, copper (II) chloride, copper (II) nitrate, copper (II) oxalate, copper (II) sulfate, copper (II) acetate, zinc (II) chloride, zinc (II) nitrate, zinc (II) oxalate, zinc (II) sulfate, zinc (II) acetate, zirconium chloride, zirconium sulfate, vanadium chloride, vanadium sulfate, molybdenum acetate, and tungsten chloride; and hydrates of these.

In a case where one would like to obtain a deposit including two or more members of the metallic elements, it is advisable to set a mixing proportion of the aforementioned compounds in the resulting aqueous solution at the same elemental ratio as an elemental ratio of the respective metallic elements in a targeted lithium-silicate-based compound.

Since it is not at all restrictive especially as to the concentrations of the respective compounds in the resulting aqueous solution, it is allowable to determine them suitably so that a uniform aqueous solution can be formed, and so that a deposit can be formed smoothly. Usually, it is permissible to set a summed concentration of compounds including iron and/or manganese at from 0.01 to 5 mol/L, or furthermore at from 0.1 to 2 mol/L.

It is also advisable that the transition-metal-containing aqueous solution can further include an alcohol. That is, in addition to using water independently as the solvent, it is also allowable to use a water-alcohol mixed solvent including a water-soluble alcohol, such as methanol and ethanol. By means of using a water-alcohol mixed solvent, it becomes feasible to generate a deposit at temperatures below 0° C. Although it is permissible that an employment amount of alcohol can be determined suitably in compliance with a targeted deposit generation temperature, and the like, it is proper to set it at an employment amount of 50 parts by mass or less with respect to water in an amount of 100 parts by mass. Note that, in the present description, the case of including an alcohol is also referred to as an “aqueous solution.”

Subsequently, a deposit (which can also be a coprecipitate) is generated from out of the transition-metal-containing aqueous solution. In order to cause a deposit to generate, it is advisable to alkalify the transition-metal-containing aqueous solution. Conditions for forming favorable deposits cannot be prescribed in general because they depend on types and concentrations of the respective compounds being included in the resulting aqueous solution. However, it is usually preferable to set the pH at 8 or more, and it is more preferable to set the pH at 11 or more.

There are not any limitations especially as to the method of alkalifying the transition-metal-containing aqueous solution; it is usually advisable to add an alkali or an aqueous solution including an alkali to the transition-metal-containing aqueous solution. Moreover, it is possible to form a deposit by means of another method as well in which the transition-metal-containing aqueous solution is added to an aqueous solution including an alkali.

As for an alkali being used in order to alkalify the transition-metal-containing aqueous solution, it is possible to use alkali-metal hydroxides, such as potassium hydroxide, sodium hydroxide and lithium hydroxide, or ammonia, for instance. Lithium hydroxide is especially preferable. This is because it is possible only for Li, which is included essentially in a targeted lithium-silicate-based compound, to turn into impurities being included in the resulting deposit. Moreover, it is possible for lithium hydroxide to adjust the pH of the resultant aqueous solution with ease. In a case where these alkalis are used as an aqueous solution, respectively, it is possible to turn them into an aqueous solution with a concentration of from 0.1 to 20 mol/L, or preferably with a concentration of from 0.3 to 10 mol/L, respectively, to use.

Moreover, in the same manner as the transition-metal-containing aqueous solution, it is also advisable to dissolve an alkali in a water-alcohol mixed solvent including a water-soluble alcohol.

There are not any limitations especially on a temperature of the resulting aqueous solution. Although it is allowable to carry out the formation of a deposit at room temperature (e.g., from 20 to 35° C.), it is also permissible to set a temperature of the resultant aqueous solution at from −50° C. to +15° C., preferably at from −40° C. to +10° C. By retaining the aqueous solution at low temperature, fine and homogeneous deposits become likely to be formed, not only because the resulting deposit is made much finer, but also because the generation of impurity phases (or spinel ferrite, for instance), which are accompanied by the generation of heat of neutralization at the time of reaction, can be inhibited.

After alkalifying the resulting aqueous solution, it is preferable to further carry out an oxidizing/aging treatment of the resultant deposit at from 0° C. to 150° C., or preferably at from 10° C. to 100° C., over a time period of from half a day to 7 days, or preferably over a time period of from a day to 4 days, while blowing air into the resulting reaction solution. Note that it is also advisable to carry the oxidizing/aging treatment at room temperature.

It is possible to refine or purify the thus obtained deposit by removing excessive alkaline components, residual raw materials, and so on, from the resulting deposit, by means of: washing the deposit with distilled water, and the like; and then filtering the deposit out.

Although the thus obtained deposited substances include iron and/or manganese essentially, it is preferable that both of the iron and manganese can have a valence of from two to four. Moreover, it is also advisable that the deposited substances can further include another metallic element, if needed. As for another metallic element, it is possible to exemplify at least one member that is selected from the group consisting of Mg, Ca, Co, Al, Ni, Nb, Ti, Cr, Cu, Zn, Zr, V, Mo, and W.

In the transition-metal-element-containing substance, it is necessary for a content of iron and/or manganese that the iron and/or manganese can be present in an amount of 50% by mol or more relative to a summed amount of metallic elements being taken as 100% by mol. That is, it is possible to set an amount of at least one member of transition metal elements, which are selected from the group consisting of Mg, Ca, Co, Al, Ni, Nb, Ti, Cr, Cu, Zn, Zr, V, Mo, and W, at from 0 to 50% by mol relative to a summed amount of the transition metal elements being taken as 100% by mol.

As to a mixing proportion between a lithium-silicate compound being expressed by Li₂SiO₃ and the transition-metal-element-containing substance, it is usually preferable to set it at such an amount that a summed amount of metallic elements being included in the transition-metal-element-containing substance can make from 0.9 to 1.2 mol, or it is more preferable to set it at such an amount that the summed amount can make from 0.95 to 1.1 mol, with respect to 1 mol of the lithium-silicate compound.

### Production Process for Lithium-silicate-based Compound

In a production process for lithium-silicate-based compound according to the present invention, it is necessary to react the above-mentioned raw-material compounds one another at from 300 to 600° C. within the above-mentioned molten salt under a mixed-gas atmosphere including carbon dioxide and a reducing gas.

Although it is not at all restrictive especially as to a specific reaction method, it is usually advisable to mix a molten-salt raw material, which includes at least one member being selected from the alkali-metal salts that have been mentioned above, a lithium-silicate compound, and the above-mentioned transition-metal-element-containing substance one another, and then to melt the molten-salt raw material by heating them to a melting point of the molten-salt raw material or more after mixing them uniformly with use of a ball mill, and the like. By means of this, the reaction between lithium, silicon and transition metal as well as the other additive metals progresses within the resulting molten salt, and thereby it is possible to obtain a targeted lithium-silicate-based compound.

On this occasion, it is not at all restrictive especially as to the mixing proportion between the lithium-silicate compound and the transition-metal-element-containing substance as well as the molten-salt raw material, and so it can be made up of amounts that enable the raw materials to disperse uniformly within the resulting molten salt. For example, it is preferable that, with respect to a summed amount of the lithium-silicate compound and transition-metal-element-containing substance that is taken as 100 parts by mass, a summed amount of molten-salt raw materials can make an amount that falls in a range of from 20 to 300 parts by mass, and it is more preferable that the summed amount can make an amount that falls in a range of from 50 to 200 parts by mass, or furthermore from 60 to 80 parts by mass.

It is advisable that a temperature of the reaction between the lithium-silicate compound and the transition-metal-element-containing substance within the resulting molten salt can be from 300 to 600° C., or furthermore from 400 to 560° C. Being less than 300° C. is not practical, because O²⁻ is less likely to be released into the resultant molten salt, and because it takes a long period of time until lithium-silicate-based compounds are synthesized.

Moreover, going beyond 600° C. is not preferable, because the particles of obtainable lithium-silicate-based compounds become likely to coarsen.

In a case where lithium-silicate-based compounds being synthesized by means of the production process according to the present invention are used respectively as a positive-electrode active material for lithium-ion secondary battery, one of the battery characteristics that upgrades remarkably is a discharging average voltage. Moreover, as will be explained in detail later, the resulting initial discharging capacity also becomes greater, so that the resultant irreversible capacity is reduced. Although an absolute value of the temperature depends on the compositions of lithium-silicate-based compounds to be synthesized, they tend to grow as plate-shaped particles when the reaction temperature be comes higher. For example, in synthesizing Li₂MnSiO₄, an Li₂MnSiO₄ powder possessing a needle-shaped or plate-shaped particle configuration is obtainable when the reaction temperature is 470° C. or more. In particular, causing the reaction at from 470 to 510° C. makes Li₂MnSiO₄ likely to grow as needle-shaped particles. Moreover, causing the reaction at from 520 to 560° C., makes Li₂MnSiO₄ likely to grow as plate-shaped particles.

The reaction being mentioned above is carried out under a mixed-gas atmosphere including carbon dioxide and a reducing gas in order to let the transition metal element, such as Fe being included in the transition-metal-containing substance, exist stably as divalent ions within the resulting molten salt during the reaction. Under this atmosphere, it becomes feasible to stably maintain the transition metal element in the divalent state even when being metallic elements whose before-reaction oxidation number is other than being divalent. Although there are not any limitations especially as to a ratio between carbon dioxide and a reducing gas, using the reducing gas more facilitates the decomposition of molten-salt raw materials so that the reaction rate becomes faster, because the carbon dioxide controlling the oxidizing atmosphere decreases. However, when the reducing gas is present excessively, divalent metallic elements in the resultant lithium-silicate-based compound are reduced by means of the resulting reducing property that is too high, and there arises a fear that the resultant product might destruct. Consequently, it is preferable to set a preferable mixing rate in the mixed gas so that the reducing gas makes from 1 to 40, or furthermore from 3 to 20, by volumetric ratio, with respect to the carbon dioxide being taken as 100. As for the reducing gas, it is possible to use hydrogen, carbon monoxide, and the like, for instance, and hydrogen is preferable especially.

As to a pressure of the mixed gas of carbon dioxide and a reducing gas, there are not any limitations especially. Although it is usually advisable to set it at an atmospheric pressure, it is even good to put the mixed gas either in a pressurized condition or in a depressurized condition.

It is usually allowable to set a time for the reaction between the lithium-silicate compound and the transition-metal-element-containing substance at from 10 minutes to 70 hours. Preferably, it is permissible to set it at from 5 to 25 hours, or furthermore at from 10 to 20 hours.

Lithium-silicate-based compounds are obtainable by means of cooling and then removing the alkali-metal salt, which has been used as a flux, after completing the above-mentioned reaction. As for a method of removing the alkali-metal salt, it is allowable to dissolve and then remove the alkali-metal salt by washing products with use of a solvent that is capable of dissolving the alkali-metal salt having been solidified by means of the post-reaction cooling. For example, it is permissible to use water as the solvent.

### Lithium-silicate-based Compound

A lithium-silicate-based compound, which is obtainable by means of the process being mentioned above, is expressed by the following compositional formula.

Compositional Formula: Li_{2+a-b}A_{b}M₁₋ₓM′ₓSi_{1+α}O_{4+c} Compositional Formula:

In the formula, “A” is at least one element that is selected from the group consisting of Na, K, Rb and Cs; “M” is at least one element that is selected from the group consisting of Fe and Mn; “M′” is at least one element that is selected from the group consisting of Mg, Ca, Co, Al, Ni, Nb, Ti, Cr, Cu, Zn, Zr, V, Mo and W; and the respective subscripts are specified as follows: 0≦“x”≦0.5; −1<“a”<1; 0≦“b”<0.2; 0≦“c”<1; and 0<“α”≦0.2). The following are preferable: −0.5≦“a”≦0.5, or furthermore −0.1≦“a”≦0.1; 0≦“b”≦0.1, or furthermore 0≦“b”≦0.05; and 0<“α”≦0.1, or furthermore 0.01≦“α”≦0.05. In a case where a lithium salt is included in the resulting molten salt, this compound makes a compound, which includes Li ions excessively, compared with the stoichiometric amount, because lithium ions in the molten salt force into the Li-ion sites in the resultant lithium-silicate-based compound interstitially. That is, the subscript “a” in the above-mentioned compositional formula becomes 0<“a.”

Moreover, since the growth of crystal grains is inhibited by means of carrying out the reaction at such a low temperature as 600° C. or less within the resulting molten salt, the compound makes such fine particles whose average particle diameters are from a few micrometers or less. In addition, the amount of impurity phases decreases greatly. As a result, in the case of being used as a positive-electrode active material for lithium-ion secondary battery, the compound makes materials having high capacities along with showing favorable cyclabilities and rate characteristics.

Note that it is possible to find the average particle diameters by means of a laser-diffraction particle-size-distribution measuring apparatus (e.g., “SALD-7100” produced by SHIMADZU Co., Ltd.) or observations by electron microscopes, such as TEM and SEM. For example, it is allowable to observe the resulting lithium-silicate-based compound with an electron microscope; and then actually measure dimensions of particles, which are identifiable with the resultant microscope photograph, for a plurality of them to find a number average of those dimensions. However, in accordance with the production process according to the present invention, the resulting lithium-silicate-based compounds' particulate configurations differ depending on the synthesis conditions as having been explained already. When an obtained compound is fine particles, it is permissible to measure a maximum value (or maximum diameter) of intervals between two parallel lines when the resultant particles are held between the parallel lines; and employ a number average value of them as an average particle diameter of those particles. When an obtained compound is needle-shaped particles, it is allowable to measure a maximum length of them and their widths at the central section; and employ number average values of them as an average length and average width of those particles. When an obtained compound is plate-shaped particles, it is permissible to measure a maximum diameter and maximum thickness of them in the planar direction; and employ number average values of them as an average diameter and average thickness of those particles.

In a case where the lithium-silicate-based compound according to the present invention comprises a powder including plate-shaped particles, it is preferable that an average diameter of the plate-shaped particles can be from 400 to 1,000 nm, or furthermore from 500 to 700 nm, and that an average thickness thereof can be from 40 to 170 nm, or furthermore from 50 to 150 nm. In a case where the lithium-silicate-based compound according to the present invention comprises a powder including needle-shaped particles, it is preferable that an average width of the needle-shaped particles can be from 30 to 180 nm, or furthermore from 50 to 150 nm, and that an average length thereof can be from 300 to 1,200 nm, or furthermore from 450 to 1,000 nm. In a case where the lithium-silicate-based compound according to the present invention comprises a powder including fine particles, it is preferable that an average particle diameter of the fine particles can be from 20 to 150 nm, or furthermore from 25 to 100 nm.

In a case where the needle-shaped and plate-shaped lithium-silicate-based compounds are used as a positive-electrode active material for lithium-ion secondary battery, they show a high capacity, respectively. In particular, the needle-shaped lithium-silicate-based compounds have a small irreversible capacity, respectively, so that they are especially good in terms of the cyclability. This is assumed to result from the following: they grow anisotropically in one direction so that needle-shaped particles are formed; and side faces of needle-shaped crystals accounting for a great area, which are formed as a consequence of that, are crystal faces that are likely to sorb and release Li in the resulting lithium-silicate-based compounds. Moreover, the plate-shaped lithium-silicate-based compounds have a high initial charging capacity and initial discharging average voltage, respectively. This is believed to result from the following: the crystallinity has become higher, because the crystals have grown. Moreover, although the lithium-silicate-based compounds being synthesized at low temperatures are fine particles for which it is impossible to make a distinction between being needle-shaped and being plate-shaped, they have a small irreversible capacity and a high cyclability, respectively, in the same manner as the needle-shaped compounds do.

Moreover, since the lithium-silicate-based compounds being synthesized at relatively low temperatures have fine-particle shapes, they exhibit an extremely large specific surface area, respectively. To be concrete, it is preferable that the specific surface area can be 15 m²/g or more, or 30 m²/g or more, or furthermore from 35 to 40 m²/g. Note that values being measured by means of nitrogen physical adsorption with use of the BET adsorption isotherm are employed for the specific surface areas in the present description.

When an X-ray diffraction measurement is carried out using an X-ray, the CuKα ray whose wavelength is 1.54 Å, for the lithium-silicate-based compounds being obtainable by means of the production process according to the present invention, 6 pieces of diffraction peaks whose relative intensity is higher are detected one after another from a low-angle side in a range in which the diffraction angle (2θ) is from 10 degrees to 80 degrees. In the lithium-silicate-based compounds comprising needle-shaped, plate-shaped or fine-particle-shaped particles, a distinctive X-ray diffraction pattern is detected, respectively.

### Carbon-coating Treatment

In the lithium-silicate-based compound that is obtainable by the process being mentioned above, and which is exhibited by the compositional formula: Li_{2+a-b}A_{b}M₁₋ₓM′ₓSi_{1+α}O_{4+c}, it is also advisable to further carry out a coating treatment by means of carbon in order to upgrade the conductivity.

As to a specific method of the carbon-coating treatment, it is not at all restrictive especially. As for a method of the carbon-coating treatment, in addition to a gas-phase method in which heat treatment is carried out in an atmosphere including a carbon-containing gas like methane gas, ethane gas and butane gas, it is feasible to apply it a thermal decomposition method as well in which an organic substance making a carbonaceous source is carbonized by means of heat treatment after mixing the organic substance with the lithium-silicate-based compound uniformly. In particular, it is preferable to apply it a ball-milling method in which a heat treatment is carried out after adding a carbonaceous material and Li₂CO₃ to the aforementioned lithium-silicate-based compound and then mixing them uniformly by means of ball milling until the resulting lithium-silicate-based compound turns into being amorphous. In accordance with this method, the lithium-silicate-based compound serving as a positive-electrode active material is turned into being amorphous by means of ball milling, and is thereby mixed uniformly with carbon so that the adhesiveness increases. In addition, it is possible to do coating, because carbon precipitates uniformly around the resultant lithium-silicate-based compound by means of the heat treatment, simultaneously with the recrystallization of the lithium-silicate-based compound. On this occasion, due to the fact that Li₂CO₃ exists, the resulting lithium-rich silicate-based compound does not at all turn into being deficient in lithium, but becomes one which shows a high charging/discharging capacity.

As to an extent of turning into being amorphous, it is advisable that a ratio, B(011)_{crystal}/B(011)ₘᵢₗₗ, can fall in a range of from 0.1 to 0.5 approximately in a case where a half-value width of the diffraction peak being derived from the (011) plane regarding a sample having crystallinity before being subjected to ball milling is labeled B(011)_{crystal} and another half-value width of the diffraction peak being derived from the (011) plane of the sample being obtained by means of ball milling is labeled B(011)ₘᵢₗₗ in an X-ray diffraction measurement in which the CuKα ray serves as the light source.

In this method, it is possible to use acetylene black (or AB), KETJENBLACK (or KB), graphite, and the like, as for the carbonaceous material.

As to a mixing proportion between the lithium-silicate-based compound, a carbonaceous material and Li₂CO₃, it is advisable to set it at from 20 to 40 parts by mass for the carbonaceous material and to set it at from 20 to 40 parts by mass for Li₂CO₃, respectively, with respect to the lithium-silicate-based compound being taken as 100 parts by mass.

The heat treatment is carried out after carrying out a ball-milling treatment until the lithium-silicate-based compound turns into being amorphous. The heat treatment is carried out under a reducing atmosphere in order to retain transition metal ions being included in the resulting lithium-silicate-based compound at divalence. As for the reducing atmosphere in this case, it is preferable to be within a mixed-gas atmosphere of carbon dioxide and a reducing gas in order to inhibit the divalent transition metal ions from being reduced to the metallic states, in the same manner as the synthesis reaction of the lithium-silicate-based compound within the molten salt. It is advisable to set a mixing proportion of carbon dioxide and that of a reducing gas similarly to those at the time of the synthesis reaction of the lithium-silicate-based compound.

It is preferable to set a temperature of the heat treatment at from 500 to 800° C. In a case where the heat-treatment temperature is too low, it is difficult to uniformly precipitate carbon around the resulting lithium-silicate-based compound. On the other hand, the heat-treatment temperature being too high is not preferable, because the decomposition or lithium deficiency might occur in the resultant lithium-silicate-based compound and thereby the resulting charging/discharging capacity declines. Moreover, it is usually advisable to set a time for the heat treatment at from 1 to 10 hours.

Moreover, as another method of the carbon-coating treatment, it is even advisable to carry out the heat treatment after adding a carbonaceous material and LiF to the aforementioned lithium-silicate-based compound and then mixing them uniformly by means of ball milling until the resulting lithium-silicate-based compound turns into being amorphous in the same manner as the method being mentioned above. In this instance, simultaneously with the recrystallization of the lithium-silicate-based compound, carbon precipitates uniformly around the aforesaid lithium-silicate-based compound to coat it and then upgrade it in the conductivity. In addition, fluorine atoms substitute for a part of oxygen atoms in the resultant lithium-silicate-based compound. Thus, a fluorine-containing lithium-silicate-based compound can be formed, the fluorine-containing lithium-silicate-based compound which is expressed by the following compositional formula.

Li_{2+a-b}A_{b}M₁₋ₓM′ₓSi_{1+α}O_{4+c-y}F_{2y} Compositional Formula:

In the formula, “A” is at least one element that is selected from the group consisting of Na, K, Rb and Cs; “M” is Fe or Mn; “M′” is at least one element that is selected from the group consisting of Mg, Ca, Co, Al, Ni, Nb, Ti, Cr, Cu, Zn, Zr, V, Mo, and W; and the respective subscripts are specified as follows: 0≦“x”≦0.5; −1<“a”<1; 0≦“b”<0.2; 0≦“c”<1; 0<“α”≦0.2; and 0<“y”<1.

This compound makes a positive-electrode material that has much better performance, because the resulting average voltage is raised by means of added F in a case where it is used as a positive electrode. On this occasion, the resultant lithium-rich silicate-based compound makes one which shows a high charging/discharging capacity, because it does not at all turn into being poor in lithium, due to the presence of LiF.

In this method, as to a mixing proportion between the lithium-silicate-based compound, a carbonaceous material and LiF, it is allowable to set it at from 20 to 40 parts by mass for the carbonaceous material and to set it at from 10 to 40 parts by mass for LiF, respectively, with respect to the lithium-silicate-based compound being taken as 100 parts by mass. In addition, it is even good that Li₂CO₃ can be further included, if needed. As to conditions of the ball milling and heat treatment, it is permissible to set them similarly to those in the case that has been mentioned above.

### Positive Electrode for Lithium-ion Secondary Battery

It is possible to effectively employ any one of the following as an active material for the positive electrode of lithium-ion secondary battery, and the like: not only the lithium-silicate-based compound that is obtainable by means of the production process according to the present invention; but also the lithium-silicate-based compound to which the carbon-coating treatment is carried out as well as the lithium-silicate-based compound to which fluorine is added. It is possible for a positive electrode using one of these lithium-silicate-based compounds to have the same structure as that of an ordinary positive electrode for lithium-ion secondary battery.

For example, it is possible to fabricate a positive electrode by means of adding a conductive additive, such as acetylene black (or AB), KETJENBLACK (or KB) or gas-phase method carbon fiber (e.g., vapor growth carbon fiber (or VGCF)), a binder, such as polyvinylidene fluoride (e.g., polyvinylidene difluoride (or PVdF)), polytetrafluoroethylene (or PTFE) or styrene-butadiene rubber (or SBR), and a solvent, such as N-methyl-2-pyrolidione (or NMP), to one of the aforementioned lithium-silicate-based compounds, turning these into being pasty, and then coating the resulting pasty product onto a current collector. As to an employment amount of the conductive additive, although it is not at all restrictive especially, it is possible to set it in an amount of from 5 to 20 parts by mass with respect to the lithium-silicate-based compound being taken as 100 parts by mass, for instance. Moreover, as to an employment amount of the binder, although it is not at all restrictive especially, either, it is possible to set it in an amount of from 5 to 20 parts by mass with respect to the lithium-silicate-based compound being taken as 100 parts by mass, for instance. Moreover, as another method, a positive electrode can also be manufactured by means of such a method in which one being made by mixing the lithium-silicate-based compound with the above-mentioned conductive additive and binder is kneaded as a film shape with use of a mortar or pressing machine and then the resultant film-shaped product is press bonded onto a current collector by a pressing machine.

As for the current collector, there are not any limitations especially, and so it is possible to use materials that have been heretofore employed conventionally as positive electrodes for lithium-ion secondary battery, such as aluminum foils, aluminum meshes and stainless steel meshes, for instance. In addition, it is possible to employ, as the current collector, carbon nonwoven fabrics and carbon woven fabrics as well.

In the positive electrode for lithium-ion secondary battery according to the present invention, it is not at all restrictive especially as to its configuration, thickness, and the like. However, it is preferable to set the thickness at from 10 to 200 μm, more preferably, at from 20 to 100 μm, for instance, by means of compressing the active material after filling it up. Therefore, it is advisable to suitably determine a fill-up amount of the active material so as to make the aforementioned thickness after being compressed, in compliance with the types, structures, and so forth, of current collectors to be employed.

### Lithium-silicate-based Compound under Charged Condition or Discharged Condition

Not only in the lithium-silicate-based compound that is obtainable by means of the production process according to the present invention; but also in the lithium-silicate-based compound to which the carbon-coating treatment has been carried out as well as in the lithium-silicate-based compound to which fluorine has been added, their crystal structures change by means of manufacturing lithium-ion secondary batteries with use of these as the positive-electrode active materials for the lithium-ion secondary batteries and then carrying out charging and discharging. A stable charging/discharging capacity comes to be obtainable because the structure changes to be stabilized by means of charging/discharging, although the lithium-silicate-based compound being obtained by doing the synthesis within the molten salt is unstable in the structure and is also less in the charging capacity. It is possible to maintain the stability highly, although the lithium-silicate-based compound comes to have different structures, respectively, under a charged condition and under a discharged condition, after its crystal structure is once changed by carrying out charging/discharging.

It is believed that this stabilization of the structure results from the following: on the occasion of synthesizing the lithium-silicate-based compound by means of the molten-salt method, alkali-metal ions (e.g., Na or K) that do not contribute to charging/discharging are introduced into the resulting lithium-silicate-based compound because they substitute for a part of the Li sites; and thereby the crystal structure is stabilized; and hence the crystal structure is maintained even when Li undergoes charging/discharging. In addition, since the ionic radius of Na (i.e., about 0.99 Å) and the ionic radius of K (i.e., about 1.37 Å) are larger than the ionic radius of Li (i.e., about 0.590 Å), the movement of Li becomes likely to occur, and so the insertion/elimination amount of Li increases, and hence it is believed to consequently lead to upgrading the charging/discharging capacity. Although a charging method and a discharging method for this instance are not at all limited especially, it is good to cause constant-electric-current charging/discharging with an electric-current value of 0.1 C for the resulting battery capacity. Although it is advisable to determine a voltage at the time of charging and discharging in compliance with the constituent elements of lithium-ion secondary battery, it is usually possible to set it in a range of from 4.8 V to 1.0 V approximately, and it is preferable to set it in a range of from 4.5 V to 1.5 V approximately, in a case where metallic lithium makes the counter electrode.

Hereinafter, crystal structures of each of the lithium-silicate-based compounds under a charged condition and under a discharged condition will be explained while giving specific examples.

### (i) Iron-containing Lithium-silicate-based Compound

First of all, an iron-containing lithium-silicate-based compound will be explained, iron-containing lithium-silicate-based compound which has been obtained by doing synthesis within a molten salt, and which is expressed by a compositional formula, Li_{2+a-b}A_{b}FeSi₁₊₊O_{4+c} (in the formula, “A” is at least one element that is selected from the group consisting of Na, K, Rb and Cs; and the respective subscripts are specified as follows: −1<“a”<1; 0≦“b”<0.2; 0≦“c”<1; and 0<“α”≦0.2).

By means of carrying out constant-current charging up to 4.2 V for a secondary battery that uses the aforesaid iron-containing lithium-silicate-based compound as the positive-electrode active material, and which uses lithium metal as the negative-electrode material, an obtainable lithium-silicate-based compound under the charged condition turns into one which is expressed by a compositional formula, Li_{1+a-b}A_{b}FeSi_{1+α}O_{4+c} (in the formula, “A,” “a,” “b,” “c,” and “a” are the same as those aforementioned).

When an X-ray diffraction measurement is carried out for the aforesaid compound with use of an X-ray whose wavelength is 0.7 Å, the relative intensities, diffraction angles and half-width values of five pieces of the resulting diffraction peaks whose relative strengths are the highest turn into the following values, respectively, in a range where the diffraction angles (or 2θ) are from 5 degrees to 40 degrees. Note that the diffraction angles and half-value widths fall within a range of ±0.03 degrees approximately about the following values.

First Peak: 100% relative intensity, 10.10-degree diffraction angle, and 0.11-degree half-value width;

Second Peak: 81% relative intensity, 16.06-degree diffraction angle, and 0.10-degree half-value width;

Third Peak: 76% relative intensity, 9.88-degree diffraction angle, and 0.14-degree half-value width;

Fourth Peak: 58% relative intensity, 14.54-degree diffraction angle, and 0.16-degree half-value width; and

Fifth Peak: 47% relative intensity, 15.50-degree diffraction angle, and 0.12-degree half-value width

When the X-ray diffraction measurement is carried out for the aforesaid compound with use of the X-ray whose wavelength is 0.7 Å, and then as a result of doing a structural analysis to a diffraction pattern, which has been obtained by carrying out the X-ray diffraction measurement with use of the X-ray whose wavelength is 0.7 Å, with a model in which the irregularization of lithium ions and iron ions has been taken into account, it has a crystal structure as described below. That is, the lithium-silicate-based compound under the charged condition has the following characteristics: the crystal system: monoclinic crystal; the space group: P2₁; the lattice parameters: a=8.3576 Å, b=5.0276 Å, c=8.3940 Å, and β=103.524 degrees; and the volume: 342.9 Å³. Note that, for the above-mentioned crystal structure, the values of the lattice parameters fall within a range of ±0.005 approximately.

Since the diffraction peaks being mentioned above are different from the diffraction peaks of the iron-containing lithium-silicate-based compound that has been synthesized within the molten salt, it is possible to ascertain that the crystal structure changes by means of charging.

Note that it is possible to measure the diffraction peaks being mentioned above by the subsequent method, for instance.

First of all, a charged electrode is washed with a linear carbonate-ester-based solvent several times, thereby removing impurities being adhered on the surfaces of the electrode. Thereafter, an electrode layer (not including the current collector) is peeled off from the obtained electrode after doing vacuum drying, is then filled up into a glass capillary, and is encapsulated in it using an epoxy-resin adhesive agent. Thereafter, it is possible to identify the lithium-silicate-based compound under charged conditions by doing an X-ray diffraction-pattern measurement with use of an X-ray whose wavelength is 0.7 Å. On this occasion, as for the linear carbonate-ester-based solvent, it is possible to use dimethyl carbonate (or DMC), diethyl carbonate (or DEC), ethyl methyl carbonate (or EMC), and the like.

Moreover, when the iron-containing lithium-silicate-based compound, which has been subjected to the charging up to 4.2 V by the method being mentioned above, is then subjected to constant-current discharging down to 1.5 V, an obtainable lithium-silicate-based compound under the discharged condition turns into one which is expressed by a compositional formula, Li_{2+a-b}A_{b}FeSi_{1+α}O_{4+c} (in the formula, “A,” “a,” “b,” “c,” and “α” are the same as those aforementioned). When an X-ray diffraction measurement is carried out for the aforesaid compound with use of an X-ray whose wavelength is 0.7 Å, the relative intensities, diffraction angles and half-width values of five pieces of the resulting diffraction peaks whose relative strengths are the highest turn into the following values, respectively, in a range where the diffraction angles (or 2θ) are from 5 degrees to 40 degrees. Note that the diffraction angles and half-value widths fall within a range of ±0.03 degrees approximately about the following values.

First Peak: 100% relative intensity, 16.07-degree diffraction angle, and 0.08-degree half-value width;

Second Peak: 71% relative intensity, 14.92-degree diffraction angle, and 0.17-degree half-value width;

Third Peak: 44% relative intensity, 10.30-degree diffraction angle, and 0.08-degree half-value width;

Fourth Peak: 29% relative intensity, 9.82-degree diffraction angle, and 0.11-degree half-value width; and

Fifth Peak: 26% relative intensity, 21.98-degree diffraction angle, and 0.14-degree half-value width

When the X-ray diffraction measurement is carried out for the aforesaid compound with use of the X-ray whose wavelength is 0.7 Å, and then as a result of doing a structural analysis to a diffraction pattern, which has been obtained by carrying out the X-ray diffraction measurement with use of the X-ray whose wavelength is 0.7 Å, with a model in which the irregularization of lithium ions and iron ions has been taken into account, it has a crystal structure as described below. That is, the lithium-silicate-based compound under the discharged condition has the following characteristics: the crystal system: monoclinic crystal; the space group: P2₁; the lattice parameters: a=8.319 Å, b=5.0275 Å, c=8.2569 Å, and β=98.47 degrees; and the lattice volume: 341.6 Å³. Note that, for the above-mentioned crystal structure, the values of the lattice parameters fall within a range of ±0.005 approximately.

Since the diffraction peaks being mentioned above are all different from any of the following: the diffraction peaks of the iron-containing lithium-silicate-based compound that has been synthesized within the molten salt; and the diffraction peaks of the post-charging iron-containing lithium-silicate-based compound, it is possible to ascertain that the crystal structure changes by means of discharging as well.

### (ii) Manganese-containing Lithium-silicate-based Compound

Next, a manganese-containing lithium-silicate-based compound will be explained, manganese-containing lithium-silicate-based compound which is obtained by doing synthesis within a molten salt, and which is expressed by a compositional formula, Li_{2+a-b}A_{b}MnSi_{1+α}O_{4+c} (in the formula, “A” is at least one element that is selected from the group consisting of Na, K, Rb and Cs; and the respective subscripts are specified as follows: −1<“a”<1; 0≦“b”<0.2; 0≦“c”<1; and 0<“α”≦0.2).

By means of carrying out constant-current charging up to 4.2 V for a lithium secondary battery that uses the aforesaid lithium-silicate-based compound as the positive-electrode active material, and which uses lithium metal as the negative-electrode material, an obtainable lithium-silicate-based compound under the charged condition turns into one which is expressed by a compositional formula, Li_{1+a-b}A_{b}MnSi_{1+α}O_{4+c} (in the formula, “A,” “a,” “b,” “c,” and “α” are the same as those aforementioned).

When an X-ray diffraction measurement is carried out for the aforesaid compound with use of an X-ray whose wavelength is 0.7 Å, the relative intensities, diffraction angles and half-width values of five pieces of the resulting diffraction peaks whose relative strengths are the highest turn into the following values, respectively, in a range where the diffraction angles (or 2θ) are from 5 degrees to 40 degrees. Note that the diffraction angles and half-value widths fall within a range of ±0.03 degrees approximately about the following values.

First Peak: 100% relative intensity, 8.15-degree diffraction angle, and 0.18-degree half-value width;

Second Peak: 64% relative intensity, 11.60-degree diffraction angle, and 0.46-degree half-value width;

Third Peak: 41% relative intensity, 17.17-degree diffraction angle, and 0.18-degree half-value width;

Fourth Peak: 37% relative intensity, 11.04-degree diffraction angle, and 0.31-degree half-value width; and

Fifth Peak: 34% relative intensity, 19.87-degree diffraction angle, and 0.29-degree half-value width

Since the diffraction peaks being mentioned above are different from the diffraction peaks of the manganese-containing lithium-silicate-based compound that has been synthesized within the molten salt, it is possible to ascertain that the crystal structure changes by means of charging.

Moreover, when the manganese-containing lithium-silicate-based compound, which has been subjected to the charging up to 4.2 V by the method being mentioned above, is then subjected to constant-current discharging down to 1.5 V, an obtainable manganese-containing lithium-silicate-based compound under the discharged condition turns into one which is expressed by a compositional formula Li_{2+a-b}A_{b}MnSi_{1+α}O_{4+c} (in the formula “A” “a” “b” “c,” and “α” are the same as those aforementioned). When an X-ray diffraction measurement is carried out for the aforesaid compound with use of an X-ray whose wavelength is 0.7 Å, the relative intensities, diffraction angles and half-width values of five pieces of the resulting diffraction peaks whose relative strengths are the highest turn into the following values, respectively, in a range where the diffraction angles (or 2θ) are from 5 degrees to 40 degrees. Note that the diffraction angles and half-value widths fall within a range of ±0.03 degrees approximately about the following values.

First Peak: 100% relative intensity, 8.16-degree diffraction angle, and 0.22-degree half-value width;

Second Peak: 71% relative intensity, 11.53-degree diffraction angle, and 0.40-degree half-value width;

Third Peak: 67% relative intensity, 11.66-degree diffraction angle, and 0.53-degree half-value width;

Fourth Peak: 61% relative intensity, 11.03-degree diffraction angle, and 0.065-degree half-value width; and

Fifth Peak: 52% relative intensity, 11.35-degree diffraction angle, and 0.70-degree half-value width

Since the diffraction peaks being mentioned above are all different from any of the following: the diffraction peaks of the manganese-containing lithium-silicate-based compound that has been synthesized within the molten salt; and the diffraction peaks of the post-charging manganese-containing lithium-silicate-based compound, it is possible to ascertain that the crystal structure changes by means of discharging as well.

Note that, in each of the iron-containing lithium-silicate-based compound and manganese-containing lithium-silicate-based compound that have been mentioned above, it is preferable that a substitution amount of element “A,” namely, the value of “b,” can be from 0.0001 to 0.05 approximately, and it is more preferable that it can be from 0.0005 to 0.02 approximately.

### Secondary Battery

It is possible to manufacture a secondary battery that uses the positive electrode for secondary battery being mentioned above by means of publicly-known methods. That is, the following and the like can be given: lithium-ion secondary batteries in which the positive electrode being mentioned above is employed as the positive-electrode material and publicly-known metallic lithium is used as the negative-electrode material; lithium-ion secondary batteries in which a carbon-based material, such as graphite, a silicon-based material, such as silicon thin films, an alloy-based material, such as copper-tin and cobalt-tin, and an oxide material, such as lithium titanate, are employed. It is advisable to follow an ordinary process in order to assemble a secondary battery while employing a solution, in which a lithium salt, such as lithium perchlorate, LiPF₆, LiBF₄ or LiCF₃SO₃, is dissolved in a concentration of from 0.5 mol/L to 1.7 mol/L in a publicly-known nonaqueous-based solvent, such as ethylene carbonate, dimethyl carbonate, propylene carbonate or dimethyl carbonate, as an electrolytic solution; and further employing the other publicly-known constituent elements for battery.

So far, some of the embodiment modes of the production process for lithium-silicate-based compound according to the present invention have been explained. However, the present invention is not one which is limited to the aforementioned embodiment modes. It is possible to execute the present invention in various modes, to which changes or modifications that one of ordinary skill in the art can carry out are made, within a range not departing from the gist.

### EXAMPLES

Hereinafter, the present invention will be explained in more detail while giving examples of the production process for lithium-silicate-based compound according to the present invention.

### Synthesis of Manganese-based Deposit

A lithium hydroxide aqueous solution was made by dissolving 2.5-mol lithium hydroxide anhydride (LiOH) in 1,000-mL distilled water. Moreover, a manganese chloride aqueous solution was made by dissolving 0.25-mol manganese chloride tetrahydrate (MnCl₂.4H₂O) in 500-mL distilled water. The lithium hydroxide aqueous solution was dropped into the manganese chloride aqueous solution gradually at room temperature (e.g., about 20° C.) for over a few hours, thereby generating a manganese-based deposit. Thereafter, air was blown into the reaction liquid including the deposit while stirring it, thereby subjecting it to a bubbling treatment at room temperature for one day. After filtering the obtained manganese-based deposit, it was then washed with distilled water about three times. The washed manganese-based deposit was dried at 40° C. for one night.

As a result of analyzing the thus obtained manganese-based deposit using X-ray diffraction, it was found to be a compound that is expressed by a compositional formula: MnOOH. That is, Mn is included in an amount of 1 mole in 1 mole of the deposit. Moreover, it was ascertained that the obtained deposit is porous by means of SEM.

### Synthesis of Manganese-containing Lithium-silicate-based Compound

### Example No. 1-1

A carbonate mixture was prepared by mixing lithium carbonate (produced by KISHIDA KAGAKU Co. Ltd., and with 99.9% purity), sodium carbonate (produced by KISHIDA KAGAKU Co. Ltd., and with 99.5% purity) and potassium carbonate (produced by KISHIDA KAGAKU Co. Ltd., and with 99.5% purity) one another in a rate of 43.5:31.5:25 by molar ratio. This carbonate mixture, 0.03 moles of the above-mentioned manganese-based deposit, and 0.03 moles of lithium silicate (e.g., Li₂SiO₃ (produced by KISHIDA KAGAKU Co. Ltd., and with 99.5% purity)) were mixed so as to let a summed amount of the manganese-based deposit and lithium silicate make a proportion of 160 parts by mass with respect to the carbonate mixture being taken as 100 parts by mass. After adding 20-mL acetone to the resulting mixture, the mixture was further mixed by a ball mill made of zirconia at a rate of 500 rpm for 60 minutes, and was then dried.

The post-drying mixed powder was heated within a golden crucible, and was then heated to 500° C. under a mixed-gas atmosphere of carbon dioxide (e.g., 100-mL/min flow volume) and hydrogen (e.g., 3-mL/min flow volume), thereby reacting it for 13 hours in a state where the carbonate mixture was fused.

After the reaction, the entirety of a reactor core including the golden crucible, namely, the reaction system, was taken from out of an electric furnace, and was then cooled rapidly down to room temperature while keeping letting the mixed gas pass through.

Subsequently, the resulting solidified reaction product was grounded with a pestle and mortar after adding water (e.g., 20 mL) to it. Then, the thus obtained powder was filtered after adding water to it in order to remove salts, and the like, from the powder, thereby obtaining a powder of manganese-containing lithium-silicate-based compound.

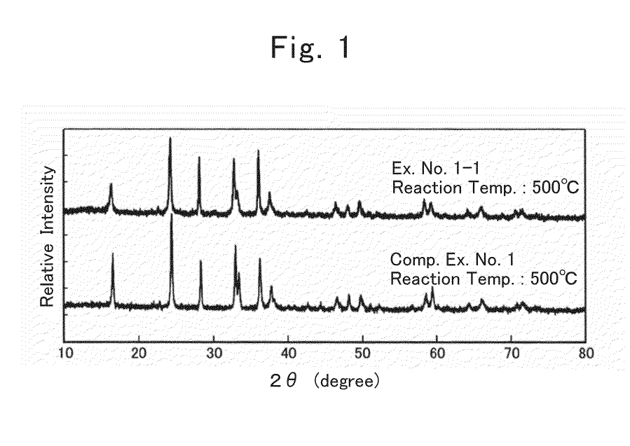

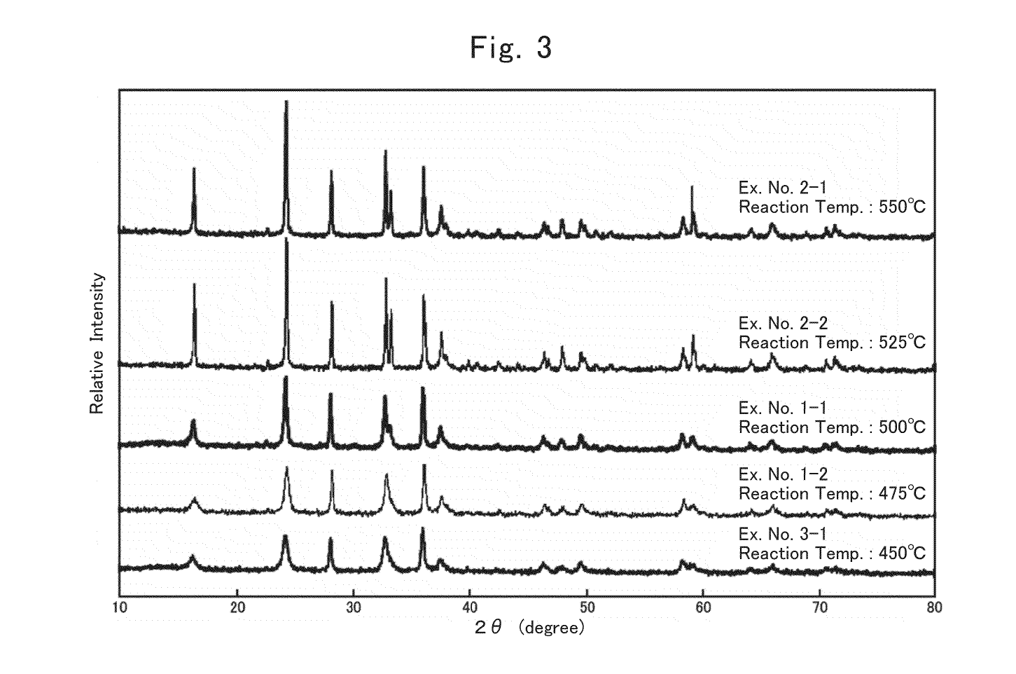

For the thus obtained product, an X-ray diffraction measurement was carried out with use of the CuKα ray whose wavelength is 1.54 Å by means of a powder X-ray diffraction apparatus. The resulting XRD pattern is shown in FIG. 1 and FIG. 3. This XRD pattern agreed with the reported pattern of orthorhombic-crystal Li₂MnSiO₄ in the space group “Pmn2₁” virtually. As a result of calculating the lattice constants by means of least-square method, they were as follows: a=6.3129(5) Å; b=5.3790(5) Å; and c=4.9689(5) Å, respectively. The computed lengths of the a-axis and c-axis showed slightly large values, compared with the values (e.g., a=6.3109 (9) Å; b=5.3800 (9) Å; and c=4.9662 (8) Å) according to a literature by R. Dominko et al., Electrochemistry Communications, 8 (2006), pp. 217-222.

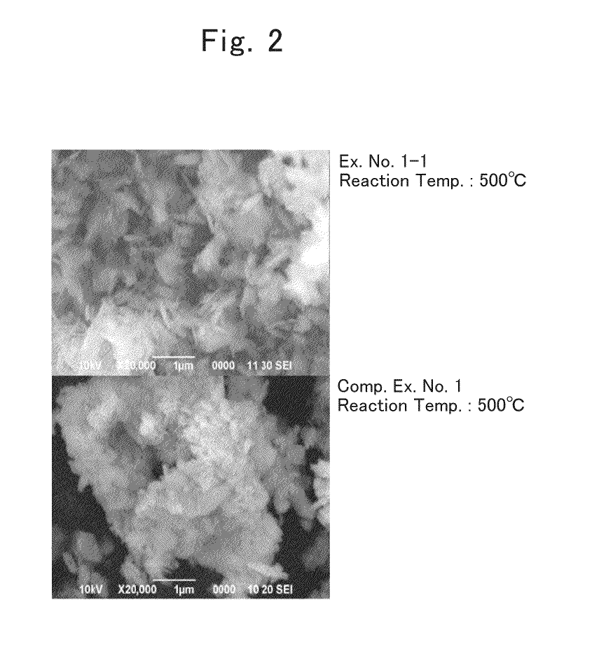

Moreover, the obtained product was observed by a scanning electron microscope (or SEM). The result is shown in FIG. 2. When ascertaining the particle size and configuration, it comprised needle-shaped particles with widths of from 50 to 150 nm, and with lengths of from 800 to 1,000 nm approximately. When computing the average width and average length by means of the above-described method, the average width was 100 nm, and the average length was 900 nm.

### Comparative Example No. 1

Using 0.03-mol manganese oxalate (MnC₂O₄.2H₂O) instead of the manganese-based deposit according to Example No. 1-1, a manganese-containing lithium-silicate-based compound was synthesized under the same synthesis conditions as those in Example No. 1-1.

For the thus obtained product, an X-ray diffraction measurement was carried out with use of the CuKα ray by means of a powder X-ray diffraction apparatus. The resulting XRD pattern is shown in FIG. 1. This XRD pattern agreed with the reported pattern of orthorhombic-crystal Li₂MnSiO₄ in the space group “Pmn2₁” virtually. As a result of calculating the lattice constants by means of least-square method, they were as follows: a=6.2935(1) Å; b=5.3561(6) Å; and c=4.9538(9) Å, respectively. All of the computed lengths of the a-axis, b-axis and c-axis showed small values, compared with the literature-based values (i.e., a 6.3109(9) Å; b=5.3800(9) Å; and c=4.9662(8) Å).

Moreover, the obtained product was observed by SEM. The result is shown in FIG. 1. When ascertaining the particle size and configuration, it comprised fine particles whose particle diameters are from 100 to 1,000 nm approximately. When calculating the average particle diameter by means of the above-described method, it was 500 nm.

### Example No. 1-2

Other than altering the heating temperature (or reaction temperature, namely, a temperature corresponding to that of the molten salt) from 500° C. to 475° C., a manganese-containing lithium-silicate-based compound was synthesized in the same manner as Example No. 1-1.

For the thus obtained product, an X-ray diffraction measurement was carried out with use of the CuKα ray by means of a powder X-ray diffraction apparatus. The resulting XRD pattern is shown in FIG. 3. This XRD pattern agreed with the reported pattern of orthorhombic-crystal Li₂MnSiO₄ in the space group “Pmn2₁” virtually. As a result of calculating the lattice constants by means of least-square method, they were as follows: a=6.3060(8) Å; b=5.3816(8) Å; and c=4.9688(2) Å, respectively. The computed lengths of the a-axis, b-axis and c-axis showed a slightly small value for the a-axis, and slightly large values for the b-axis and c-axis, compared with the literature-based values (i.e., a=6.3109(9) Å; b=5.3800(9) Å; and c=4.9662(8) Å).

Moreover, the obtained product was observed by SEM. The result is shown in FIG. 7. When ascertaining the particle size and configuration, it comprised needle-shaped particles with widths of from 50 to 130 nm, and with lengths of from 300 to 1,000 nm approximately. When computing the average width and average length by means of the above-described method, the average width was 80 nm, and the average length was 500 nm.

### Example No. 2-1

Other than altering the heating temperature from 500° C. to 550° C., a manganese-containing lithium-silicate-based compound was synthesized in the same manner as Example No. 1-1.

For the thus obtained product, an X-ray diffraction measurement was carried out with use of the CuKα ray by means of a powder X-ray diffraction apparatus. The resulting XRD pattern is shown in FIG. 3. This XRD pattern agreed with the reported pattern of orthorhombic-crystal Li₂MnSiO₄ in the space group “Pmn2₁” virtually. As a result of calculating the lattice constants by means of least-square method, they were as follows: a=6.3133(4) Å; b=5.3771(4) Å; and c=4.9671(5) Å, respectively. The computed lengths of the a-axis, b-axis and c-axis showed slightly large values for the a-axis and c-axis, and slightly small value for the b-axis, compared with the literature-based values (i.e., a=6.3109(9) Å; b=5.3800(9) Å; and c=4.9662(8) Å).

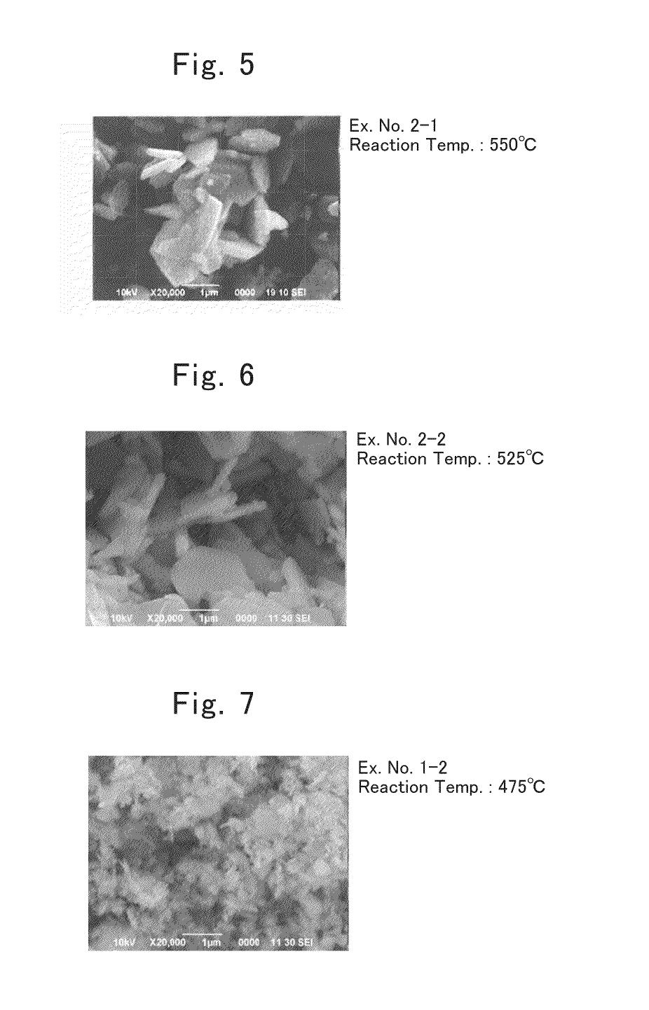

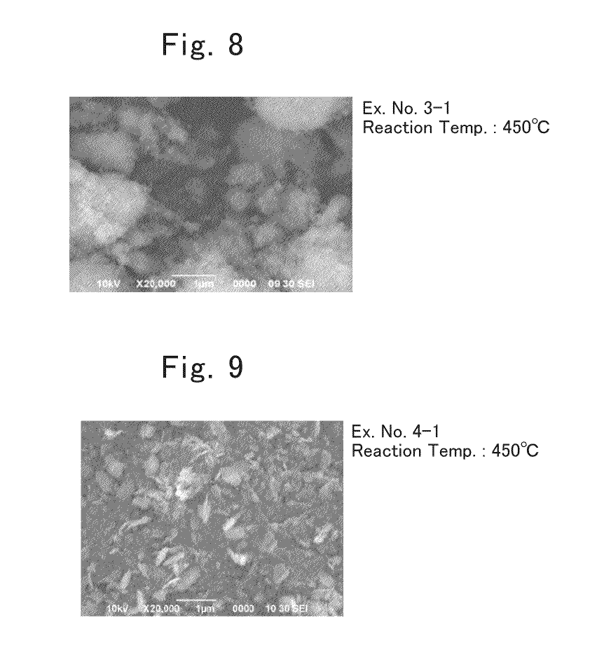

Moreover, the obtained product was observed by SEM. The result is shown in FIG. 5. When ascertaining the particle size and configuration, it comprised plate-shaped particles with longitudinal diameters of from 400 nm to a few micrometers, and with thicknesses of from 40 to 150 nm approximately. When computing the average diameter and average thickness by means of the above-described method, the average diameter was 600 nm, and the average thickness was 70 nm.

### Example No. 2-2

Other than altering the heating temperature from 500° C. to 525° C., a manganese-containing lithium-silicate-based compound was synthesized in the same manner as Example No. 1-1.

For the thus obtained product, an X-ray diffraction measurement was carried out with use of the CuKα ray by means of a powder X-ray diffraction apparatus. The resulting XRD pattern is shown in FIG. 3. This XRD pattern agreed with the reported pattern of orthorhombic-crystal Li₂MnSiO₄ in the space group “Pmn2₁” virtually. As a result of calculating the lattice constants by means of least-square method, they were as follows: a=6.3163(7) Å; b=5.3789(1) Å; and c=4.9703(2) Å, respectively. The computed lengths of the a-axis, b-axis and c-axis showed slightly large values for the a-axis and c-axis, compared with the literature-based values (i.e., a=6.3109(9) Å; b=5.3800(9) Å; and c=4.9662(8) Å).

Moreover, the obtained product was observed by SEM. The result is shown in FIG. 6. When ascertaining the particle size and configuration, it comprised plate-shaped particles with longitudinal diameters of from 400 nm to a few micrometers, and with thicknesses of from 80 to 150 nm approximately. When computing the average diameter and average thickness by means of the above-described method, the average diameter was 600 nm, and the average thickness was 100 nm.

### Example No. 3-1

Other than altering the heating temperature from 500° C. to 450° C., a manganese-containing lithium-silicate-based compound was synthesized in the same manner as Example No. 1-1.

For the thus obtained product, an X-ray diffraction measurement was carried out with use of the CuKα ray by means of a powder X-ray diffraction apparatus. The resulting XRD pattern is shown in FIG. 3. This XRD pattern agreed with the reported pattern of orthorhombic-crystal Li₂MnSiO₄ in the space group “Pmn2₁” virtually. As a result of calculating the lattice constants by means of least-square method, they were as follows: a=6.3144(6) Å; b=5.3750(6) Å; and c=4.9728(4) Å, respectively. The computed lengths of the a-axis, b-axis and c-axis showed slightly large values for the a-axis and c-axis, and slightly small value for the b-axis, compared with the literature-based values (i.e., a=6.3109(9) Å; b=5.3800(9) Å; and c=4.9662(8) Å).

Moreover, the obtained product was observed by SEM. The result is shown in FIG. 7. When ascertaining the particle size and configuration, it comprised fine particles whose particle diameters are 100 nm or less. When computing the average particle diameter by means of the above-described method, it was 50 nm.

### Example No. 4-1

The subsequent procedure was followed to synthesize a manganese-based deposit with added iron. A lithium hydroxide aqueous solution was made by mixing 2.5-mol lithium hydroxide (LiOH) in 1,000-mL distilled water. Moreover, an iron-manganese aqueous solution was made by dissolving 0.225-mol manganese chloride tetrahydrate (MnCl₂.4H₂O) and 0.025-mol iron (III) nitrate nonahydrate (Fe(NO₃)₃.9H₂O) in 500-mL distilled water. The lithium hydroxide aqueous solution was dropped into the iron-manganese aqueous solution gradually, thereby generating an iron-added manganese-based deposit. Thereafter, air was blown into the reaction liquid including the deposit, thereby subjecting it to a bubbling treatment at room temperature for one day. After filtering the obtained iron-added manganese-based deposit, it was then washed with distilled water about three times. The washed iron-added manganese-based deposit was dried at 40° C. for one night.

Other than altering the deposit to the iron-added manganese-based deposit, a manganese-containing lithium-silicate-based compound (e.g., Li₂Mn_{0.9}Fe_{0.1}SiO₄), in which iron substituted for 10% of manganese, was synthesized in the same manner as Example No. 3-1.

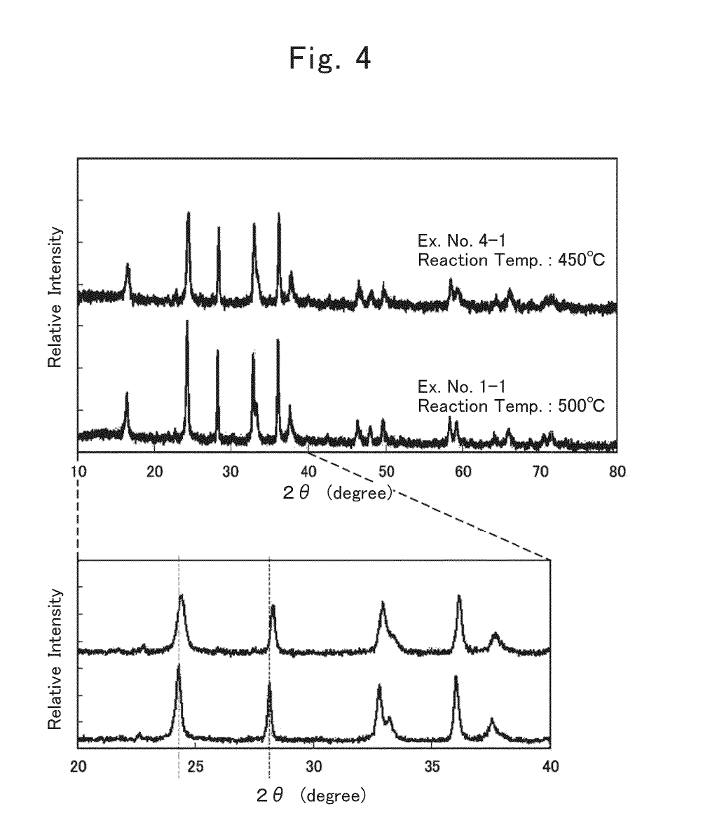

For the thus obtained product, an X-ray diffraction measurement was carried out with use of the CuKα ray by means of a powder X-ray diffraction apparatus. The resulting XRD pattern is shown in FIG. 4. Although this XRD pattern agreed with the reported pattern of orthorhombic-crystal Li₂MnSiO₄ in the space group “Pmn2₁” virtually, the shift in the peak positions, which indicates the doped iron, was observed.

As a result of calculating the lattice constants by means of least-square method, they were as follows: a=6.3023(2) Å; b=5.3614(7) Å; and c=4.9611(3) Å, respectively. All of the computed lengths of the a-axis, b-axis and c-axis showed slightly small values, compared with the lattice constants of the manganese-containing lithium silicate being obtained by means of the process according to Example No. 3-1 (i.e., a=6.3144(6) Å; b=5.3750(6) Å; and c=4.9728(4) Å).

Moreover, the obtained product was observed by SEM. The result is shown in FIG. 9. When ascertaining the particle size and configuration, it comprised needle-shaped particles with widths of from 50 to 200 nm, and with lengths of from 200 to 800 nm approximately. When computing the average width and average length by means of the above-described method, the average width was 100 nm, and the average length was 500 nm.

### Composition Analysis

The compositions of the manganese-containing lithium-silicate compounds, which were obtained by means of the processes according to Example Nos. 1-1, 2-1 and 3-1 as well as Comparative Example No. 1, were analyzed by means of ICP emission spectroscopy. The analyzed results are given in Table 1. The analyzing procedure will be hereinafter explained. The used ICP emission-spectroscopy analyzing apparatus was “CIROS-120EOP” that was produced by RIGAKU AND SPECTRO Corp.

### Measurement of Specific Surface Area

The specific surface areas of the manganese-containing lithium-silicate compounds, which were obtained by means of the processes according to Example Nos. 1-1, 2-1 and 3-1 as well as Comparative Example No. 1, were measured by means of nitrogen physical adsorption method in which the BET adsorption isotherm was used. The analyzed results are given in Table 1.

TABLE 1

| | | Synthesis | Specific | |
|---|---|---|---|---|
| | Raw Material for | Temperature | Surface Area | Result of Composition |
| | Manganese | (° C.) | (m²/g) | Analysis |
| Ex. No. 1-1 | Manganese-based | 500 | 19.4 | Li_{2.019}Na_{0.030}K_{0.017}MnSi_{1.130}O_{4.288} |
| | Deposit | | | |
| Ex. No. 2-1 | Manganese-based | 550 | 7.4 | Li_{2.011}Na_{0.013}K_{0.007}MnSi_{1.044}O_{4.796} |
| | Deposit | | | |
| Ex. No. 3-1 | Manganese-based | 450 | 36.9 | Li_{1.910}Na_{0.010}K_{0.007}MnSi_{1.050}O_{3.993} |
| | Deposit | | | |
| Comp. Ex. | Manganese | 500 | 12.5 | Li_{1.909}Na_{0.020}K_{0.012}MnSi_{1.009}O_{3.920} |
| No. 1 | Oxalate | | | |

In the manganese-containing lithium-silicate-based compounds that were obtained by means of the processes according to the respective examples given in Table 1, the contents of silicon were more excessive than the stoichiometric composition. However, in the manganese-containing lithium-silicate-based compound that was obtained by means of the process according to Comparative Example No. 1, since the silicon content deviated from the stoichiometric composition only within an error range, it was not possible to synthesize such compounds as containing silicon excessively. Moreover, the manganese-containing lithium-silicate-based compound, which was obtained by means of the process according to Example No. 3-1, had a fine particle shape in the same manner as that of Comparative Example No. 1 did. However, in accordance with the process according to Example No. 3-1, it was understood that very fine particles whose specific surface areas are very large are obtainable.

### On Lattice Constants

As being mentioned above, the Fe-free manganese-containing lithium silicates, which were obtained by means of the processes according to the respective examples, had the a-axis, b-axis and c-axis at least one of which was greater than the literature-based values when their lattice constants were compared with the literature-based values.

### Making of Secondary Battery

Any one of the manganese-containing lithium-silicate-based compounds, which were obtained by means of the processes according to the respective examples and the comparative example, was used as a positive-electrode active material, thereby making a lithium secondary battery, respectively.

25 parts by mass of a mixture of acetylene black (or AB) and PTFE (e.g., a mixture with a ratio, AB:PTFE=2:1 by mass) was added with respect to 100 parts by mass of the lithium-silicate-based compounds, respectively. Then, an electrode was prepared by forming the resulting mixtures as a film shape after kneading them, press attaching them onto an aluminum current collector, and vacuum drying them at 140° C. for 3 hours, respectively. Thereafter, atrial coin battery was made with use of the following: a solution serving as the electrolytic solution, solution in which LiPF₆ was dissolved in a concentration of 1 mol/L in a mixture having a ratio, ethylene carbonate (or EC): dimethylene carbonate (or DMIC)=1:1; a polypropylene film (e.g., “CELGARD 2400” produced by CELGARD) serving as the separator; and a lithium-metal foil serving as the negative electrode. In the thus obtained coin batteries, the battery in which the synthesis process for the positive-electrode active material was Example No. 1-1 was labeled #11; the battery in which the synthesis process for the positive-electrode active material was Example No. 1-2 was labeled #12; the battery in which the synthesis process for the positive-electrode active material was Example No. 2-1 was labeled #21; the battery in which the synthesis process for the positive-electrode active material was Example No. 2-2 was labeled #22; the battery in which the synthesis process for the positive-electrode active material was Example No. 3-1 was labeled #31; the battery in which the synthesis process for the positive-electrode active material was Example No. 4-1 was labeled #41; and the battery in which the synthesis process for the positive-electrode active material was Comparative Example No. 1 was labeled #C1.

### Charging/Discharging Test

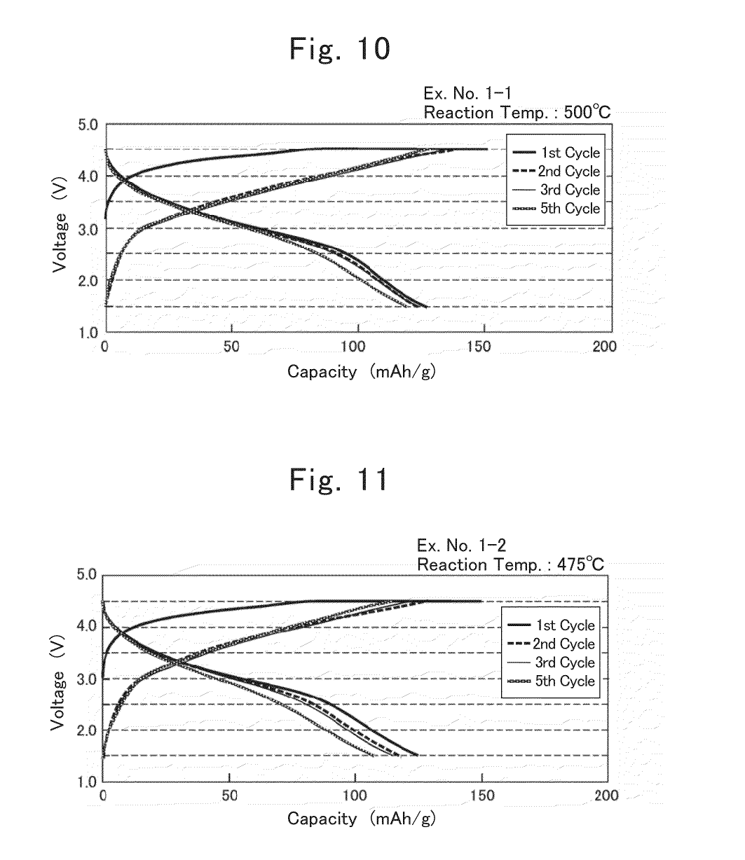

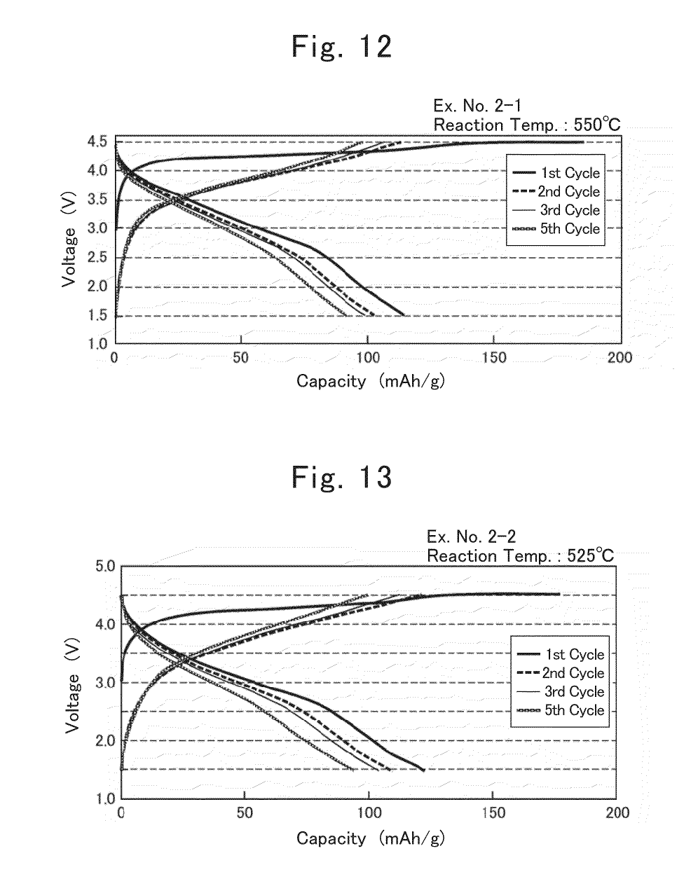

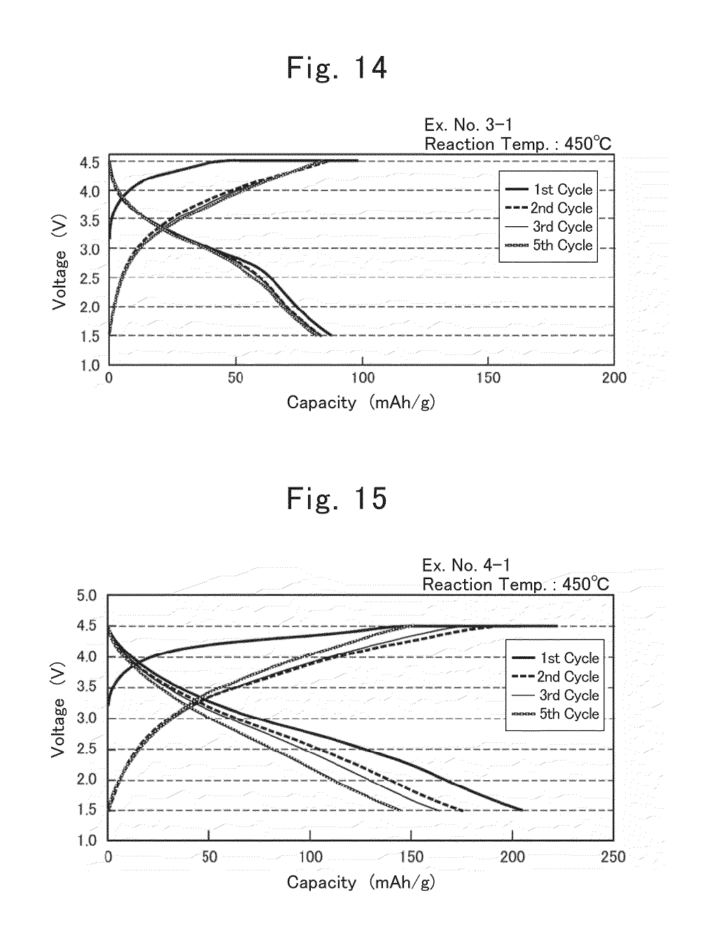

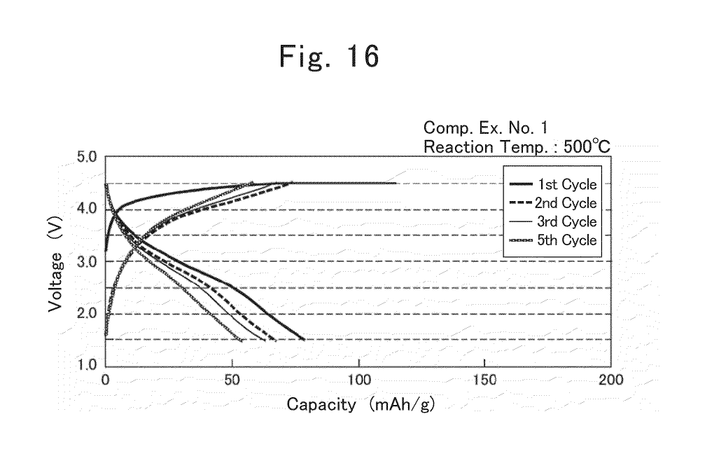

A charging/discharging test was carried out at 30° C. for these coin batteries. The testing conditions were set as follows: over a voltage of from 4.5 to 1.5 V with 0.1 C; note however that a first-round constant-voltage charging was done at 4.5 V for 10 hours. The results are shown in FIG. 10 through FIG. 16, and Table 2. FIG. 10 through FIG. 16 are charging/discharging curve diagrams from the first cycle up to fifth cycle.

TABLE 2

| | | | Results of Charging/Discharging Test | | | | | |
|---|---|---|---|---|---|---|---|---|
| | | | | | Initial- | Initial | Post-5th- | Post-5th-cycle |
| | Lithium-silicate-based | | Initial | Initial | discharging | Charging/ | cycle | Discharging |
| | Compound | | Charged | Discharged | Average | Discharging | Discharged | Average |
| Battery | Synthesis | SEM | Capacity | Capacity | Voltage | Efficiency | Capacity | Voltage |
| No. | Temp. (° C.) | Observation | mAh/g | mAh/g | V | % | mAh/g | V |
| #11 | 500 | Needle | 150.22 | 126.75 | 2.90 | 84.38 | 119.01 | 2.87 |
| | | Shape | | | | | | |
| #12 | 475 | Needle | 149.60 | 124.68 | 2.86 | 83.34 | 107.66 | 2.80 |
| | | Shape | | | | | | |
| #21 | 550 | Plate | 185.06 | 114.14 | 2.93 | 61.68 | 91.39 | 2.86 |
| | | Shape | | | | | | |
| #22 | 525 | Plate | 176.46 | 122.06 | 2.84 | 69.17 | 94.16 | 2.74 |
| | | Shape | | | | | | |
| #31 | 450 | Fine | 98.44 | 87.29 | 2.86 | 88.67 | 81.79 | 2.84 |
| | | Particle | | | | | | |
| #41 | 450 | Needle | 220.91 | 204.61 | 2.75 | 92.62 | 144.06 | 2.70 |
| | | Shape | | | | | | |
| #C1 | 500 | Fine | 113.37 | 78.50 | 2.74 | 69.24 | 54.09 | 2.64 |
| | | Particle | | | | | | |

Any one the six types of Batteries #11 through #41 given in Table 2 showed a discharging average voltage that was equal to or more than that of Battery #C1. Among these, there existed those whose initial charged capacities, initial charging/discharging efficiencies and post-fifth-cycle discharged-capacity maintenance rates were better than those of Battery #C1. Hereinafter, the explanations will be made individually.

Batteries #11 and #12 are a lithium secondary battery in which the lithium-silicate-based compounds being synthesized by means of the production processes according to Example No. 1-1 and Example No. 1-2 were used as the positive-electrode active material, respectively. According to the SEM observation on the compound that was obtained in Example No. 1-1, and on the compound that was obtained in Example No. 1-2, any one of them had particles whose configuration was a needle shape. Moreover, according to the X-ray diffraction patterns, any one of the compounds had a broader peak, which is seen at around 16 degrees and which is derived from the (010) plane, than that of the other compounds that were synthesized in the other examples. That is, the crystallinity of the compounds being obtained in Example Nos. 1-1 and 1-2 was lower. In addition, the intensity of another diffraction peak, which is seen at around 24 degrees and which is derived from the (011) plane, was not one which was noticeable. It was understood that the batteries according to #11 and #12, in which such a lithium-silicate-based compound was used as the positive-electrode active material, were smaller in the irreversible capacity, and were especially better in the cyclability (e.g., the post-fifth-cycle capacity maintenance rate was 94% for Battery #11, and was 86% for Battery #12), respectively.

Batteries #21 and #22 are a lithium secondary battery in which the lithium-silicate-based compounds being synthesized by means of the production processes according to Example No. 2-1 and Example No. 2-2 were used as the positive-electrode active material, respectively. According to the SEM observation on the compound that was obtained in Example No. 2-1, and on the compound that was obtained in Example No. 2-2, any one of them had particles whose configuration was a plate shape. Moreover, according to the X-ray diffraction patterns, any one of the compounds had a sharper peak, which is seen at around 16 degrees and which is derived from the (010) plane, than that of the other compounds that were synthesized in the other examples. That is, in accordance with Example Nos. 2-1 and 2-2, the compounds with higher crystallinity were obtained. In addition, a main peak with the highest intensity was another diffraction peak that is seen at around 24 degrees and that is derived from the (011) plane. It was understood that the batteries according to #21 and #22, in which such a lithium-silicate-based compound was used as the positive-electrode active material, were higher in the initial charged capacity and initial-discharging average voltage, respectively.

Battery #31 are a lithium secondary battery in which the lithium-silicate-based compound being synthesized by means of the production process according to Example No. 3-1 was used as the positive-electrode active material. According to the SEM observation on the compound that was obtained in Example No. 3-1, the particles were so fine extremely that it was difficult to identify the configuration. Moreover, according to the X-ray diffraction pattern, any one of the diffraction peaks was broader, and so the crystallinity was lower. In addition, the intensity of another peak, which is seen at around 24 degrees and which is derived from the (011) plane, was lower. That is, the X-ray diffraction pattern of the compound being synthesized in Example No. 3-1 approximated the X-ray diffraction patterns of the compounds being synthesized in Example Nos 1-1 and 1-2. It was understood that the battery according to #31, in which such a lithium-silicate-based compound was used as the positive-electrode active material, were smaller in the irreversible capacity, and were higher in the cyclability (e.g., the post-fifth-cycle capacity maintenance rate was 94%), in the same manner as #11.

Battery #41 is a lithium secondary battery in which the lithium-silicate-based compound being synthesized by means of the production process according to Example No. 4-1 was used as the positive-electrode active material. According to the SEM observation on the compounds that were obtained in Example No. 4-1, the particles hada needle shape. Moreover, according to the X-ray diffraction pattern, any one of the compounds had a broader diffraction peak, which is seen at around 16 degrees and which is derived from the (010) plane, than that of the other compounds that were synthesized in the other examples. That is, the crystallinity of the compounds being obtained in Example Nos. 4-1 was lower. In addition, the intensity of another diffraction peak, which is seen at around 24 degrees and which is derived from the (011) plane, was not one which was noticeable. Although it is believed that the battery according to #41, in which such a lithium-silicate-based compound was used as the positive-electrode active material, was smaller in the irreversible capacity, and was higher in the cyclability in the same manner as #11, the irreversible capacity got smaller strikingly by means of the doped iron. Moreover, Battery #41 showed higher charged capacities and discharged capacities.

Battery #C1 is a lithium secondary battery in which the lithium-silicate-based compound being synthesized by means of the production process according to Comparative Example No. 1 was used as the positive-electrode active material. According to the SEM observation on the compound that was obtained in Comparative Example No. 1, the particles were so fine that it was difficult to identify the configuration. Moreover, according to the X-ray diffraction pattern, any one of the diffraction peaks is sharp, and so the crystallinity was higher. It was understood that the battery according to #C1, in which such a lithium-silicate-based compound was used as the positive-electrode active material, was greater in the irreversible capacity, was lower in the initial-discharging average voltage, and was lower in the cyclability (e.g., the post-fifth-cycle capacity maintenance rate was 690), although it was not so great in the initial charged capacity.

### Analysis on X-ray Diffraction Patters

In the X-ray diffraction patterns shown in FIG. 1, FIG. 3 and FIG. 4, the relative intensity, diffraction angle (2θ) and half-value width of the 6 pieces of the diffraction peaks, whose diffraction intensity was the most intense, were read out. The results are given in Table 3. Note that, in Table 3, the relative intensities are taken relatively with respect to one of the diffraction peaks whose relative intensity was the maximum value that is regarded as 100.

In the X-ray diffraction patterns of the lithium-silicate-based compounds including plate-shaped particles that were synthesized by means of the processes according to Example No. 2-1 and Example No. 2-2, the intensity of a diffraction peak, which is seen at around 33 degrees and which is derived from the (200) plane, was higher than that of another diffraction peak, which is seen at around 36 degrees and which is derived from the (020) plane. Moreover, the intensity of this diffraction peak, which is seen at around 33 degrees and which is derived from the (200) plane, was higher than that of the other diffraction peak, which is seen at around 28 degrees and which is derived from the (111) plane. In addition, at around 33 degrees, two peaks were seen to clearly separate from each another.

On the other hand, in the X-ray diffraction patterns of the lithium-silicate-based compounds including needle-shaped or fine-particle-shaped particles that were synthesized by means of the processes according to Example Nos. 1-1, 1-2, 3-1 and 4-1, the intensity of a diffraction peak, which is seen at around 33 degrees and which is derived from the (200) plane, was lower than that of another diffraction peak, which is seen at around 36 degrees and which is derived from the (020) plane. Moreover, in the X-ray diffraction patterns of the lithium-silicate-based compounds that were synthesized by means of the processes according to Example Nos. 1-1, 1-2 and 3-1, the intensity of the diffraction peak, which is seen at around 33 degrees and derived from the (200) plane, was lower than that of the other diffraction peak, which is seen at around 28 degrees and which is derived from the (111) plane.

TABLE 3

| | | | | Half- |
|---|---|---|---|---|
| | | Relative | Diffraction | value |
| | | IntenSity | Angle | Width |
| Ex. | 1st | 100.0 | 24.301 | 0.285 |
| No. 1-1 | Peak | | | |
| | 2nd | 84.6 | 36.059 | 0.208 |
| | Peak | | | |
| | 3rd | 76.1 | 28.149 | 0.174 |
| | Peak | | | |
| | 4th | 73.1 | 32.801 | 0.310 |
| | Peak | | | |
| | 5th | 36.1 | 16.381 | 0.333 |
| | Peak | | | |
| | 6th | 29.5 | 33.224 | 0.446 |
| | Peak | | | |
| Ex. | 1st | 100.0 | 36.140 | 0.248 |
| No. 1-2 | Peak | | | |
| | 2nd | 83.2 | 24.346 | 0.418 |
| | Peak | | | |
| | 3rd | 79.8 | 28.224 | 0.218 |
| | Peak | | | |
| | 4th | 71.3 | 32.913 | 0.470 |
| | Peak | | | |
| | 5th | 26.7 | 37.657 | 0.335 |
| | Peak | | | |
| | 6th | 26.4 | 16.467 | 0.482 |
| | Peak | | | |
| Comp. | 1st | 100.0 | 24.470 | 0.243 |
| Ex. | Peak | | | |
| No. 1 | 2nd | 67.4 | 32.973 | 0.267 |
| | Peak | | | |
| | 3rd | 55.9 | 16.566 | 0.222 |
| | Peak | | | |
| | 4th | 52.5 | 36.232 | 0.271 |
| | Peak | | | |
| | 5th | 50.7 | 28.330 | 0.221 |
| | Peak | | | |
| | 6th | 37.3 | 33.425 | 0.277 |
| | Peak | | | |
| Ex. | 1st | 100.0 | 24.338 | 0.170 |
| No. 2-1 | Peak | | | |
| | 2nd | 63.2 | 32.848 | 0.162 |
| | Peak | | | |
| | 3rd | 51.3 | 36.115 | 0.194 |
| | Peak | | | |
| | 4th | 49.1 | 16.429 | 0.176 |
| | Peak | | | |
| | 5th | 48.5 | 28.207 | 0.156 |
| | Peak | | | |
| | 6th | 33.6 | 33.289 | 0.213 |
| | Peak | | | |
| Ex. | 1st | 100.0 | 24.343 | 0.167 |
| No. 2-2 | Peak | | | |
| | 2nd | 59.7 | 32.855 | 0.161 |
| | Peak | | | |
| | 3rd | 54.4 | 16.434 | 0.155 |
| | Peak | | | |
| | 4th | 49.1 | 36.121 | 0.195 |
| | Peak | | | |
| | 5th | 44.8 | 28.215 | 0.155 |
| | Peak | | | |
| | 6th | 38.9 | 33.296 | 0.166 |
| | Peak | | | |
| Ex. | 1st | 100.0 | 36.051 | 0.259 |
| No. 3-1 | Peak | | | |
| | 2nd | 81.0 | 24.275 | 0.468 |
| | Peak | | | |
| | 3rd | 78.9 | 28.174 | 0.241 |
| | Peak | | | |
| | 4th | 78.4 | 32.826 | 0.484 |
| | Peak | | | |
| | 5th | 27.6 | 16.423 | 0.522 |
| | Peak | | | |
| | 6th | 24.6 | 37.567 | 0.448 |
| | Peak | | | |
| Ex. | 1st | 100.0 | 36.175 | 0.234 |
| No. 4-1 | Peak | | | |
| | 2nd | 98.9 | 24.439 | 0.377 |
| | Peak | | | |
| | 3rd | 87.1 | 32.933 | 0.397 |
| | Peak | | | |
| | 4th | 86.0 | 28.284 | 0.235 |
| | Peak | | | |
| | 5th | 37.5 | 16.489 | 0.390 |
| | Peak | | | |
| | 6th | 34.5 | 37.729 | 0.447 |
| | Peak | | | |

1. A silicon-rich lithium-silicate-based compound being characterized in that:
the silicon-rich lithium-silicate-based compound is being expressed by a compositional formula:
Li_{2+a-b}A_{b}M₁₋ₓM′ₓSi_{1+α}O_{4+c}:
where “A” is at least one element that is selected from the group consisting of Na, K, Rb and Cs;
“M” is at least one element that is selected from the group consisting of Fe and Mn;
“M′” is at least one element that is selected from the group consisting of Mg, Ca, Co, Al, Ni, Nb, Ti, Cr, Cu, Zn, Zr, V, Mo and W; and
the respective subscripts are specified as follows:
0≦“x”≦0.5;
−1<“a”<1;
0≦“b”<0.2;
0≦“c”<1; and
0<“α”≦0.2;
in the formula.

2. The lithium-silicate-based compound as set forth in claim 1 comprising:
a powder that includes plate-shaped particles, and which exhibits, in an X-ray diffraction measurement using the CuK_{α} ray, diffraction peaks (i.e., 2θ) in which a diffraction peak appearing in the vicinity of 33 degrees is higher than another diffraction peak appearing in the vicinity of 36 degrees; or
a powder that includes needle-shaped particles or fine particles, and which exhibits 2θs in which a diffraction peak appearing in the vicinity of 33 degrees is lower than another diffraction peak appearing in the vicinity of 36 degrees.

3. The lithium-silicate-based compound as set forth in claim 1 comprising a powder that includes:
plate-shaped particles whose average diameter is from 400 to 1,000 nm and average thickness is from 40 to 170 nm;
needle-shaped particles whose average width is from 30 to 180 nm and average length is from 300 to 1,200 nm; or
fine particles whose specific surface area is 15 m²/g or more.

4. A production process for silicon-rich lithium-silicate-based compound, the production process being characterized in that:
in a production process for lithium-silicate-based compound in which a lithium-silicate compound being expressed by Li₂SiO₃ is reacted with a transition-metal-element-containing substance including at least one member being selected from the group consisting of iron and manganese at from 300° C. or more to 600° C. or less within a molten salt including at least one member being selected from the group consisting of alkali-metal salts under a mixed-gas atmosphere including carbon dioxide and a reducing gas;
said transition-metal-element-containing substance includes a deposit that is formed by alkalifying a transition-metal-containing aqueous solution including a compound that includes at least one member being selected from the group consisting of iron and manganese.

5. The production process for lithium-silicate-based compound as set forth in claim 4, wherein said deposit includes at least one member that is selected from the group consisting of iron and manganese whose oxidation numbers are from divalence to tetravalence.

6. The production process for lithium-silicate-based compound as set forth in claim 4, wherein said transition-metal-containing aqueous solution includes at least one of the following: manganese (II) chloride, manganese (II) nitrate, manganese (II) sulfate, manganese (II) acetate, manganese (III) acetate, manganese (II) acetylacetonate, potassium permanganate (VII), manganese (III) acetylacetonate, iron (II) chloride, iron (III) chloride, iron (III) nitrate, iron (II) sulfate; and hydrates of these.

7. The production process for lithium-silicate-based compound as set forth in claim 4, wherein said deposit is formed by dropping a lithium hydroxide aqueous solution into said transition-metal-containing aqueous solution.

8. The production process for lithium-silicate-based compound as set forth in claim 4, wherein said lithium-silicate compound and said transition-metal-element-containing substance are reacted one another at from 400° C. or more to 560° C. or less.

9. The production process for lithium-silicate-based compound as set forth in claim 4, wherein said molten salt includes a lithium salt.

10. The production process for lithium-silicate-based compound as set forth in claim 4, wherein said molten salt includes at least one of member of alkali metal-carbonates, alkali-metal nitrates, and alkali-metal hydroxides.

11. The production process for lithium-silicate-based compound as set forth in claim 4, wherein said transition-metal-element-containing substance includes:
at least one member of transition metal elements being selected from the group consisting of iron and manganese in an amount of from 50 to 100% by mol; and
at least one member of metallic elements being selected from the group consisting of Mg, Ca, Co, Al, Ni, Nb, Ti, Cr, Cu, Zn, Zr, V, Mo and W in an amount of from 0 to 50% by mol;
when a summed amount of metallic elements being included in the transition-metal-element-containing substance is taken as 100% by mol.

12. The production process for lithium-silicate-based compound further including a step of removing said alkali-metal salt by means of a solvent after producing a lithium-silicate-based compound by the process as set forth in claim 4.

13. A positive-electrode active material for lithium-ion secondary battery, the positive-electrode active material comprising the lithium-silicate-based compound as set forth in claim 1.

14. A positive electrode for lithium-ion secondary battery, the positive electrode including the positive-electrode active material for lithium-ion secondary battery as set forth in claim 13.

15. A lithium-ion secondary battery including the positive electrode for lithium-ion secondary battery as set forth in claim 14 as a constituent element.

16. A positive-electrode active material for lithium-ion secondary battery, the positive-electrode active material comprising a lithium-silicate-based compound that is obtained by means of the process as set forth in claim 4.

17. A positive electrode for lithium-ion secondary battery, the positive electrode including the positive-electrode active material for lithium-ion secondary battery as set forth in claim 16.

18. A lithium-ion secondary battery including the positive electrode for lithium-ion secondary battery as set forth in claim 17 as a constituent element.
